(19) United States
(12) Patent Application Publication
(10) Pub. No.: US 2016/0191855 A1
(43) Pub. Date: Jun. 30, 2016

(54) Sensor Deployment With Target Regions

(71) Applicant: Invent.ly LLC, Woodside, CA (US)

(72) Inventors: Hector H. Gonzalez-Banos, Mountain View, CA (US); Asif Ghias, Novato, CA (US)

(21) Appl. No.: 14/624,989

(22) Filed: Feb. 18, 2015

Related U.S. Application Data
(63) Continuation-in-part of application No. 14/586,608, filed on Dec. 30, 2014.

(51) Int. Cl. H04N 7/18; G01B 21/00

(52) U.S. Cl. CPC H04N 7/181; G01B 21/00

(57) ABSTRACT

The invention teaches an effective deployment strategy for sensors based on finding a set-cover solution of computational geometry. The system and methods of the invention teach embodiments to deploy sensors of varying capabilities in a workspace with real-world constraints. The workspace comprises a set of target regions or cells that are required to be observed. Sensor capabilities include having sensing stations with different types of sensors operating simultaneously to provide sensing, network or other types of coverages. Constraints include having range and directional constraints on the sensors, requiring sensing stations to be placed only within certain predetermined regions or locations of the workspace, and having a limited number of a certain type of sensors available. The invention finds a variety of real-world applications including tracking, coverage, and social media.

### RELATED APPLICATIONS

This application is a continuation-in-part of U.S. patent application Ser. No. 14/586,608 filed on Dec. 30, 2014 and incorporated herein in its entirety.

### FIELD OF THE INVENTION

This invention relates generally to the fields of computational geometry, combinatorics, set theory, linear programming, computer science, distributed/mobile sensor networks, wireless sensor networks, smart sensor networks and in particular to determining effective placement of different types of sensors in varied environments.

### BACKGROUND ART

There are a number of related disciplines with similar and sometimes conflated names such as wireless sensor networks, distributed sensor networks, mobile sensor networks, ubiquitous sensor networks, smart sensor networks that are concerned with effectively deploying various types of sensors in diverse environments for a large variety of industrial applications. It is no surprise that sensor deployment in such disciplines remains an active area of academic and industrial pursuit. With the ubiquity of sensors such as smart phones and other smart devices pervading through our daily lives, with concepts such as internet of things (IOT) maturing over the last decade, and with the interconnectedness of the world fast becoming a reality, it is no surprise that a large number of technology companies and academic institutions are spending a vast amount of resources in developing programs and products for deploying the ever increasing universe of sensors in the most effective manner possible.

In as far as devising strategies for deploying sensors, there are many schemes taught in the prior art. “A Randomized Art-Gallery Algorithm for Sensor Placement” by Hector Gonzalez-Banos et al. of Stanford University (2001) describes a placement strategy for computing a set of ‘good’ locations where visual sensing will be most effective. The sensor placement strategy relies on a randomized algorithm that solves a variant of the art-gallery problem known to those skilled in the art. The strategy finds a minimum set of guards inside a polygonal workspace from which the entire workspace boundary is visible. To better take into account the limitations of physical sensors, the algorithm computes a set of guards that satisfies incidence and range constraints.

“Coverage by directional sensors in randomly deployed wireless sensor networks” by Jing Ai et al. of Rensselaer Polytechnic Institute (2005) teaches a novel ‘coverage by directional sensor’ problem with tunable orientations on a set of discrete targets. It proposes a Maximum Coverage with Minimum Sensors (MCMS) problem in which coverage in terms of the number of targets to be covered is maximized whereas the number of sensors to be activated is minimized. The paper presents its exact Integer Linear Programming (ILP) formulation and an approximate (but computationally efficient) centralized greedy algorithm (CGA) solution. These centralized solutions are used as baselines for comparison. Then it provides a distributed greedy algorithm (DGA) solution. By incorporating a measure of the sensors residual energy into DGA, it further develops a Sensing Neighborhood Cooperative Sleeping (SNCS) protocol which performs adaptive scheduling on a larger time scale. Finally, it evaluates the properties of the proposed solutions and protocols in terms of providing coverage and maximizing network lifetime through extensive simulations.

“Selection and Orientation of Directional Sensors for Coverage Maximization” by Giordano Fusco et al. of Stony Brook University (2009) addresses the problem of selection and orientation of directional sensors with the objective of maximizing coverage area. Sensor nodes may be equipped with a ‘directional’ sensing device (such as a camera) which senses a physical phenomenon in a certain direction depending on the chosen orientation. The paper addresses the problem of selecting a minimum number of sensors and assigning orientations such that the given area (or set of target points) is k-covered (i.e., each point is covered k times). The above problem is NP-complete, and even NP-hard to approximate. The paper presents a simple greedy algorithm that delivers a solution that k-covers at least half of the target points using at most M log(k|C|) sensors, where |C| is the maximum number of target points covered by a sensor and M is the minimum number of sensors required to k-cover all the given points.

In “Efficient Sensor Placement for Surveillance Problems”, Agarwal et al. of Duke University (2009) studies the problem of covering by sensors of a two-dimensional spatial region P that is cluttered with occluders. A sensor placed at a location p covers a point x in P if x lies within sensing radius r from p and x is visible from p, i.e., the segment px does not intersect any occluder. The goal is to compute a placement of the minimum number of sensors that cover P. It proposes a landmark-based approach for covering P.

In “On Sensor Placement for Directional Wireless Sensor Networks”, Osais of Carleton University, Ottawa (2009) discusses a directional sensor network that is formed by directional sensors which may be oriented toward different directions. The sensing region of a directional sensor can be viewed as a sector in a two-dimensional plane. Therefore, a directional sensor can only choose one sector (or direction) at any time instant. They discuss the placement of such directional sensors as a critical task in the planning of directional sensor networks. They also present an integer linear programming model whose goal is to minimize the number of directional sensors that need to be deployed to monitor a set of discrete targets in a sensor field. Numerical results demonstrate the viability and effectiveness of the model.

In general, the problem of sensor placement in an occluded workspace is well studied. Such a system 10 of prior art is illustrated in FIG. 1. System 10 comprises of a workspace 12 that contains several obstructions 14. Specifically, there are 6 obstructions in workspace 12 as illustrated in FIG. 1. An effective sensor placement strategy addresses the problem of finding the optimal (minimum) number of locations where sensors, for example cameras, that need to be placed in workspace 12 such that any part of the entire workspace is visible to at least one sensor. Such a solution in the literature is sometimes referred to as a 1-guard solution.

Further, a system 20 of prior art is illustrated in FIG. 2, in which sensor 16 is placed in workspace 12 as shown such that areas within workspace 12 as depicted by the hatch pattern are visible to sensor 16, assuming a straight line of sight visibility model for sensor 16. Note, that no other range or direction constraint is placed on the visibility model of sensor 16 as depicted in FIG. 2. Several prior art teachings describe strategies for placement of such sensors inside workspace 12 such that any part of workspace 12 is visible to at least one sensor 16 despite obstructions 14 in workspace 12.

A shortcoming of prior art teachings is that they do not provide a strategy for sensor deployment that includes multiple sensors or sensing stations, each with different sensing/visibility models and constraints. Further, the prior art assumes a simple sensing model for the sensors that is a based on an individual type of sensor, rather than a composite visibility model that is based on a collection of various types of sensors on a given sensing station. A further shortcoming of the prior art is that it generally conflates the notions of ‘sensing coverage’ that is concerned with sensing a set of target sites or other sensors or sensed stations in a workspace, and ‘network coverage’ that is concerned with connecting or communicating with the target sites in the workspace, sometimes using a different type of sensor or transceiver. The prior art teachings are also silent on the notions of ‘localizability coverage’, which we refer to as the capability to determine the location of a sensed station by knowing the positions of two or more sensing stations—as will be taught in the detailed description section. Additionally still, prior art teachings fail to disclose above teachings in the context of a workspace that is decomposed or tessellated into individual regions or cells.

### OBJECTS OF THE INVENTION

In view of the shortcomings of the prior art, it is an object of the present invention to teach a more effective deployment strategy for sensors than is available through the teachings of the prior art.

It is further an object of the invention to allow sensing stations having multiple types of sensors, each with its own sensing model and constraints.

It is further an object of the invention to incorporate sensing coverage, network coverage and localizability coverage simultaneously in the deployment of sensors as taught by the present invention.

It is further an object of the invention to treat the workspace as having cells or target regions that are required to be monitored.

### SUMMARY OF THE INVENTION

The objects and advantages of the invention are given by a system and methods for determining a set of placement sites from a set of candidate sites in a workspace. The candidate sites refer to the potential locations and other configuration information of sensing stations in the workspace, while the placement sites determined or computed by the system comprise those candidate sites where the sensing stations should be placed or deployed in order to ensure coverage. The system further comprises a set of target sites in the workspace. The target sites refer to the potential locations and configurations of sensed stations in the workspace. The system further comprises zero or more obstructions in the workspace that would obstruct the sensing of the sensed stations by the sensing stations in the workspace.

Each sensing station has one or more sensing regions around it, each such sensing region likely but not necessarily existing due to individual sensors on the sensing station. The sensing region is defined as the set of all sites within the workspace that are able to be sensed by that sensing station in the workspace, despite the obstructions. The sensing region is further constrained by a sensing range and a sensing orientation of the corresponding sensing station. Subsequently, a composite sensing region for each sensing station is defined as the collection of the individual sensing regions of the sensing station.

Corresponding to a set of candidate sites, a set of ranges having the same size as the set of candidate sites is defined. Each range in the set of ranges is selected to be the subset of the set of target sites such that the sensed stations at the target sites in the subset are all able to be sensed by the sensing station at that candidate site corresponding to the range. As stated, the cardinality of the set of ranges is the same as the set of candidate sites being considered. The system determines the near-optimal set of such candidate sites in the workspace to be the placement sites (or the computed solution) based on a minimum set-cover solution for the set system comprising the set of all target sites, and the set family comprising the set of all the ranges above.

In the preferred embodiment, the collection of individual sensing regions of a sensing station is taken to be a union of the individual sensing regions. Alternatively, the collection is taken to be an intersection of the individual sensing regions. Still in another embodiment, the collection is taken to be based on a generic set operation of the individual sensing regions of the sensing station.

Preferably, the target sites are merely the locations of interest that need to be observed in the workspace. Hence, there is no sensor or device present at the location that needs to be observed in the workspace in such a preferred embodiment. In another preferred embodiment, the set of placement sites determined by the system guarantees that each sensed station is able to be sensed by at least two sensing stations at a given point in time. This capability affords the determination of the location of a sensed station or a target site by triangulation. If each sensed station is able to be sensed by three or more sensing stations then this capability affords the determination of the location of a sensed station or target site by trilateration.

In another preferred embodiment, the candidate site comprises the location of the site in two or three dimensions in the workspace, and the angle(s) of orientation of the sensing station placed at that candidate site in two or three dimensional Euclidean space respectively. Preferably, the angle(s) of orientation is/are unconstrained or omni-directional, so that the candidate site merely refers to the location of the placement of the sensing station.

Similarly, in another preferred embodiment, the target site comprises the location of the site in two or three dimensions in the workspace, and the angle(s) of orientation of the sensed station placed at that target site in two or three dimensions respectively. Preferably, the angle(s) of orientation is/are unconstrained or omni-directional, so that the target site merely refers to the location of the placement of the sensed station.

In a highly preferred embodiment, each sensed station also has one or more sensed regions around it, likely but not necessarily, as a result of the individual sensors present on the sensed station. A sensed region of a sensed station at a target site is defined as the set of all sites around that sensed station that if overlapping with the sensing region of a sensing station at a candidate site in the workspace will result in that sensed station being sensed by that sensing station. Preferably, the sensing region of a sensing station at a candidate site and a sensed region of a sensed station at a target site are defined such that the sensing station can sense the sensed station only if the sensed station is in the sensing region of the sensing station and the sensing station is in the sensed region of the sensed station.

Preferably, the sensed region is further constrained by a sensed range and a sensed orientation of the sensed station. Preferably, there is a composite sensed region around each sensed station that is a collection of the individual sensed regions around the sensed station. Preferably, each range in the set of ranges above is further chosen such that the candidate site corresponding to the range lies in the sensed region of the sensed stations placed at the target sites of that range.

In the preferred embodiment, the collection of individual sensed regions of a sensed station is taken to be a union of the individual sensed regions. Alternatively, the collection is taken to be an intersection of the individual sensed regions. Still in another embodiment, the collection is taken to be based on a generic set operation of the individual sensed regions of the sensed station.

Preferably, the candidate sites determined by the apparatus and methods of the invention overlap with the target sites. Alternatively, the candidate sites determined by the invention do not overlap with the target sites. In another advantageous embodiment there is another constraint placed on the apparatus and methods of the invention that requires the placement sites to be have locations chosen from a set of predetermined locations in the workspace. Similarly, in another embodiment the constraint placed is such that the placement sites can only be chosen from a predetermined region in the workspace. Still in another preferred embodiment, there is a predetermined number of a certain type of sensors available.

In a highly preferred embodiment, the set-cover solution determined by the invention is based on the popular Greedy algorithm. Preferably the minimum set-cover solution is derived in polynomial time. Still preferably, the solution derived is of the order in Big-O notation at most a factor of [symbol] (d log dC*) from its optimal size C*, where d denotes the Vapnik-Chervonenkis dimension (VC-dimension) of the set system comprising the set of all target sites and the set family comprising the set of ranges. Still preferably, the VC-dimension is bounded by [symbol] (log h) where h represents the number of obstructions in the workspace.

In a highly preferred embodiment, the sensing station is a camera and the target sites comprise a surveillance space that needs to be monitored. In another preferred embodiment, the sensing stations and the sensed stations are wireless sensors operating substantially in the popular 60 GHz frequency range. In still another preferred embodiment, a sensing station is a three-dimensional object in a video, whether the video is pre-recorded or streaming, while the workspace itself comprises the video. In another preferred embodiment, the sensing stations and sensed stations are people, the workspace is a geographical place or terrain, and the candidate and target sites are the coordinates of the locations of the particular sites where the above people i.e. sensing and stations respectively, are to be located in the given workspace or the geographical place or the terrain. In a highly preferred set of embodiments, a sensing station is a person while the workspace comprises a social graph. In a variation of the same embodiment, the sensing station is a product while the workspace comprises a social graph.

Related to the above embodiments having target sites, or locations, or points that are required to be observed, the invention further discloses an alternative set of embodiments that are based on target regions that need to be monitored or sensed by sensing stations. Such target regions can be as a result of a decomposition of the workspace or its region of interest), into a grid, or cells, or as a result of some other scheme for the creation of target regions of any shape or size whose coverage is required. This process of decomposition of a space into one or more geometric shapes is also referred to as tessellation or cell-decomposition, as will be familiar to skilled artisans. For these alternative set of embodiments a sensing region of a sensing station at a candidate site is defined as a collection of all those target regions in the workspace such that the sensing station is able to sense each such target region if the sensing station can sense a sensed station located anywhere in a certain portion of the target region as determined by a measure of the target region above a predetermined threshold, despite the present obstructions. This measure can be any property or function of the target region being sensed. Furthermore, each target region could have this measure defined uniquely for that target region, or two or more target regions in the workspace can have the same measure.

Preferably the measure represents the area of the target region, and preferably still it represents the volume of the target region. This measure, in fact, can be any portion of the target region as represented by a mathematical expression, or a group of points, locations, features, contours, topographical features, etc. of the target region that are required to be observed. In the preferred embodiment, this measure is a length of the perimeter of the target region. In an alternative embodiment, this measure is a number of vertices of the target region. These embodiments are useful for applications where there is a requirement of providing/guarding a ‘fence’ around the target region as measured by the fraction of the perimeter or a minimum number of vertices of the perimeter of the target region. In these embodiments, the requirement will be to monitor the sensed stations placed on the perimeter of the target region, despite the present obstructions.

Preferably the threshold is 100% of the value of the measure. In other words, if the measure represents the area or volume of the target region and the threshold is 100%, that means that the requirement is for the target region to be fully contained in the sensing region of the sensing station in order for the target region to be visible to the sensing station.

According to the apparatus and methods of the invention, a set of all target regions in the workspace is defined. Such a set is also sometimes referred to as the ‘ground set’. Then a set of ranges is defined such that each range in the set of ranges is selected to be the subset of the set of target regions (i.e. the ground set), such that the target regions in the subset are all able to be sensed by the sensing station at that candidate site corresponding to the range. Obviously, the cardinality of the set of ranges is the same as the set of candidate sites being considered, because corresponding to each candidate site, there is an observe-able set of target regions i.e. the range. The system determines the near-optimal set of such candidate sites in the workspace to be the placement sites (or the computed solution) based on a minimum set-cover solution for the set system comprising the set of all target regions, and the set family comprising the set of all the ranges above.

All earlier teachings remain applicable to this alternative set of embodiments comprising target regions, except that the definition of a sensing region of a sensing station at a candidate site is adapted to cover a target region (and not just a site, location or point) as governed by a measure of the target region that needs to be above a predetermined threshold in order for the whole target region to be considered visible to the sensing station. A collection of all such target regions that are visible to or sensed by the sensing station thus comprises the sensing region of that sensing station. Further to this updated notion of the sensing region as taught above, the set of ranges is selected to be sets of target regions (instead of target sites), each such set or range visible to a sensing station at the candidate site corresponding to that range. The sensor deployment solution is then determined to be the set-cover solution for the set system comprising the set of all target regions, and the set family comprising the set of all the ranges, per above teachings.

Clearly, the system and methods of the invention find many advantageous embodiments. The details of the invention, including its preferred embodiments, are presented in the below detailed description with reference to the appended drawing figures.

### BRIEF DESCRIPTION OF THE DRAWING FIGURES

FIG. 1 is a sensor deployment system of the prior art for deployment of sensors in a workspace with obstructions.

FIG. 2 is the sensor deployment system of FIG. 1 containing a sensor without range or directional constraints.

FIG. 3 is a sensor deployment system according to the present invention for deploying a variety of sensors in a workspace with obstructions.

FIG. 4 is a deployment strategy for system of FIG. 3 according to the present invention, depicting the placement of sensors to cover the entirety of the interior of the workspace, excluding obstructions.

FIG. 5 shows a discrete sampling of the workspace of FIG. 3 and FIG. 4.

FIG. 6 shows a sensor deployment system of the current invention where discretely sampled target sites are non-overlapping with the candidate sites.

FIG. 7 shows a variation of the sensor deployment system of FIG. 3 with the added constraint that sensors can only be placed in predetermined regions, and only a limited quantity of certain types of sensors are available.

FIG. 8 shows a solution to the sensor deployment system of

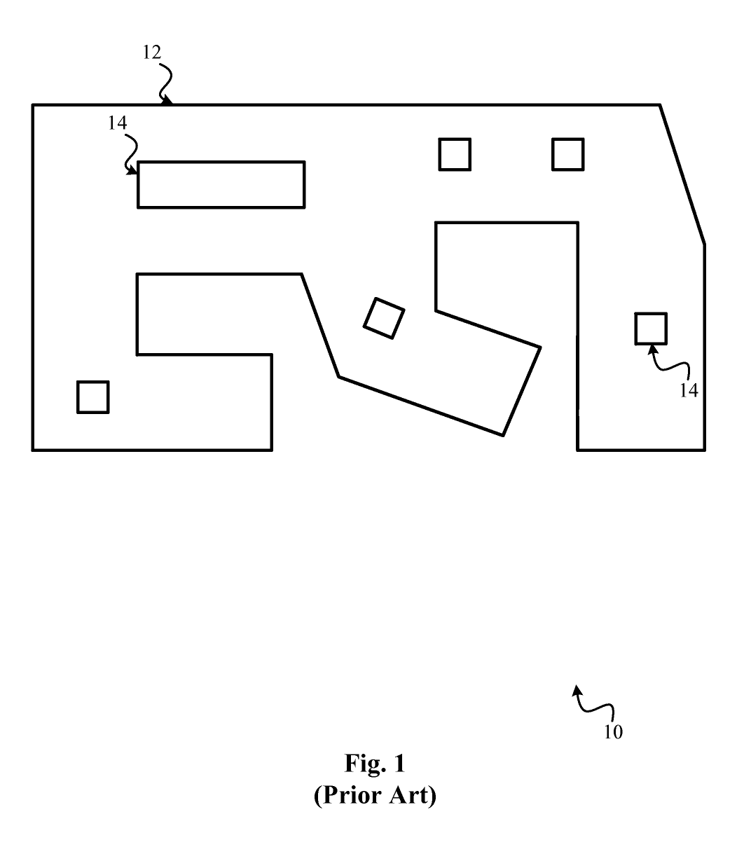

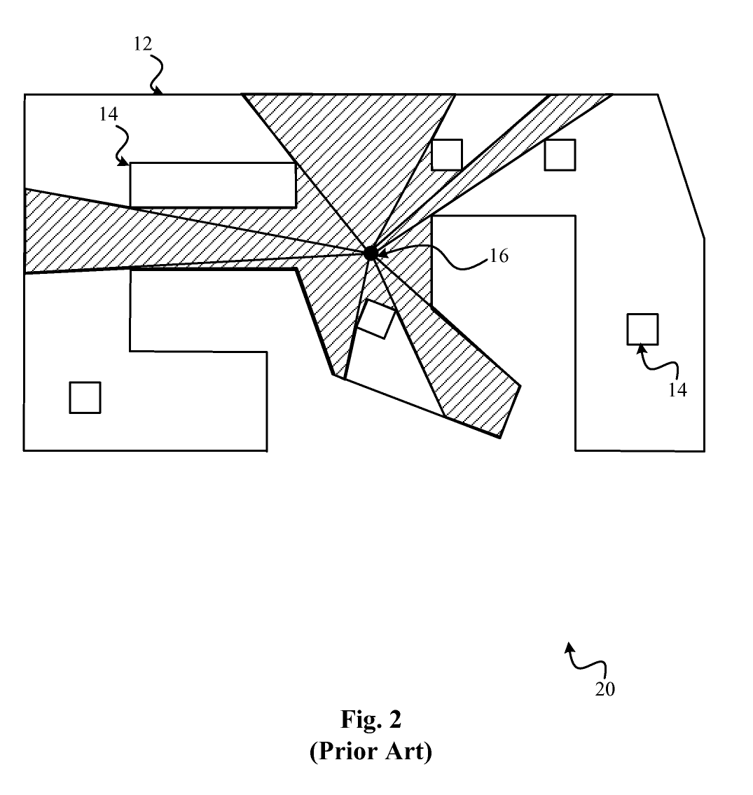

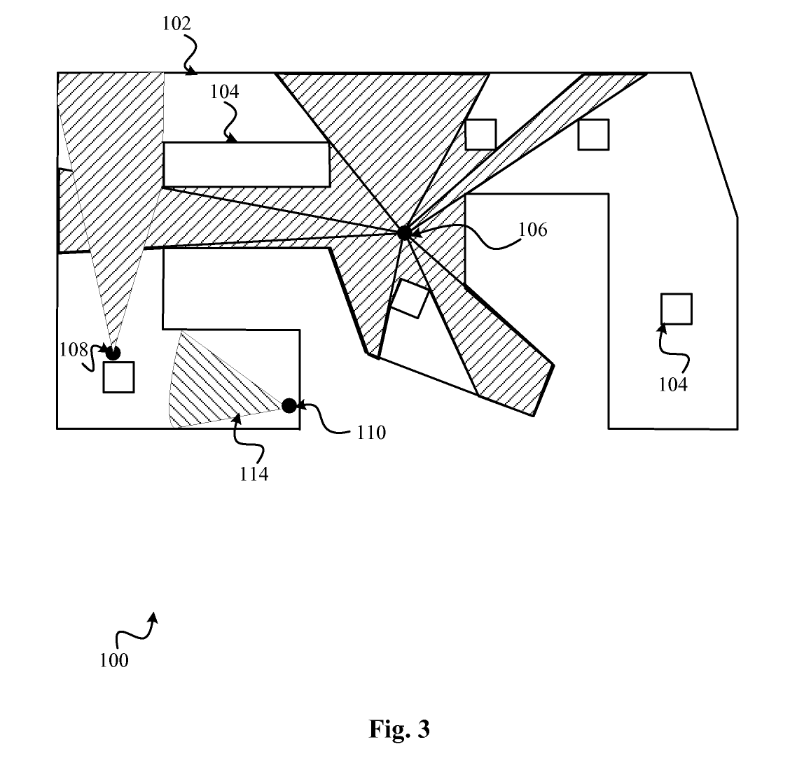

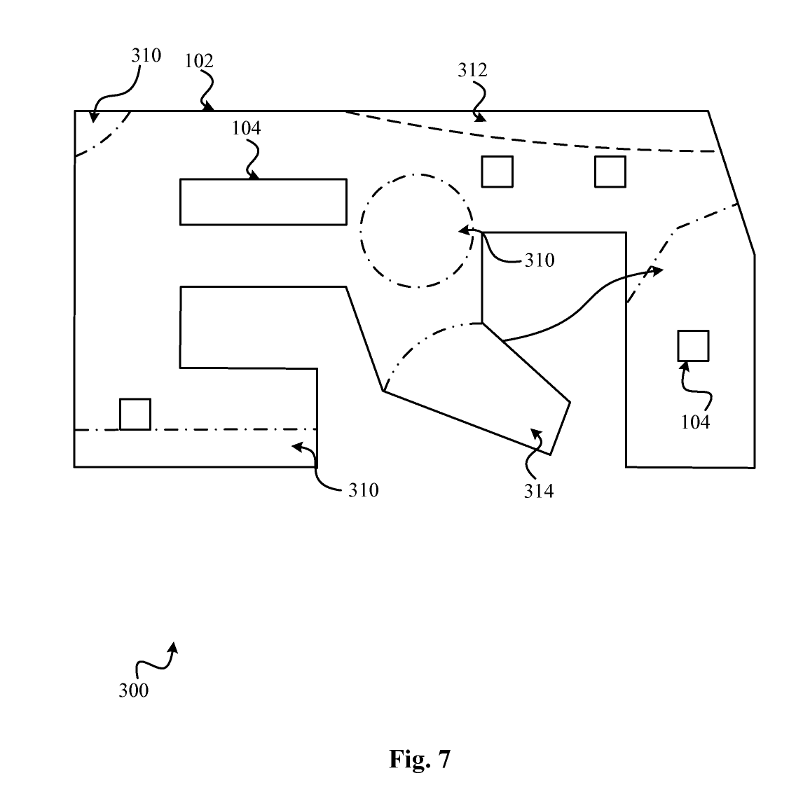

FIG. 7 according to the present invention.

FIG. 9 shows a 3-D perspective view of a sensor deployment system according to the instant invention with a sensed station having a sensed region that intersects with the sensing region of a sensing station.

FIG. 10 shows an embodiment of the present invention with a deployment strategy for a sensing station with the constraint of having a predetermined region where the sensing station can be deployed, and a sensed station with a sensed region that has to overlap with the sensing region of the sensing station in order for it to provide coverage.

FIG. 11 shows an embodiment of the present invention, with a more restrictive definition of sensing and sensed regions such that in order to provide coverage, the sensing station has to be in the sensed region of the sensed station, and the sensed station has to be in the sensing region of the sensing station.

FIG. 12 shows an embodiment of the present invention as applied to social media. Specifically, the invention uses a social graph to be the workspace, and sensing and sensed stations to be people within the social graph.

FIG. 13 shows a computed cover by the present invention to the embodiment of FIG. 12.

FIG. 14 shows an alternative embodiment with workspace having cells or regions, including target regions marked by ‘X’.

FIG. 15A-C illustrate the effect of sensing region of a sensing station and its sensing of a target region selected from the embodiment of FIG. 14.

FIG. 16 represents a variation of above embodiments where the target region contains a set of points of interest, a certain number of which are required to be observed for the entire target region to be considered visible or sensed.

FIG. 17 shows a variation of the system of FIG. 3 comprising a workspace that is decomposed into a regular grid.

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

The present invention will be best understood by first reviewing the sensor deployment system 100 illustrated in FIG. 3. FIG. 3 illustrates a workspace 102 in two dimensions that has a number of obstructions 104 as indicated. FIG. 3 and associated explanation below, as well as other embodiments taught later will be explained taking advantage of the clarity of two dimensional illustrations where possible. Those skilled in the art will readily recognize that the below teachings are directly applicable to a three dimensional environment and the reference to two dimensional illustrations are for convenience only. Wherever possible, three dimensional illustrations will also be provided in the below teachings for completeness.

Workspace 102 has six obstructions 104 as indicated in FIG. 3. FIG. 3 also illustrates a sensing station 106 that is omni-directional, that is, it has no constraint on its orientation. Generally available radio receivers are an example of such omni-directional sensing stations or sensors. Furthermore, sensing station 106 does not have any range constraint within the context of workspace 102. In other words, the range of sensing station 106 is infinite compared to the dimensions of workspace 102. It will be obvious to those skilled in the art, that any real receiver will have a finite range of reception or a receiving range. However, for the purpose of explaining the current embodiment in regards to sensing station 106, we will assume that such range of sensing station 106 is substantially more than the dimensions of workspace 102.

Throughout the following explanation workspace 102 will be assumed to comprise of a collection of sites embodied by its interior, excluding obstructions 104. Generally, a site will represent a physical location in the workspace and additional configuration information of the sensor present at that location. The terms, a site, a point or location may be used interchangeably in the following explanation, and distinction between them will be drawn where needed and appropriate. Furthermore in the following text, where appropriate, the term sensor may be used to refer to a sensing station as well as a sensed station, when the distinction between the two is obvious from the context.

Sensor deployment system 100 of FIG. 3 also has a sensor 108 that has no sensing range constraint, but has sensing orientation or a directional constraint. Further explained, the reception range of sensing station 108 is larger than the dimensions of workspace 102 and its orientation constraint is shown by the direction of its hatched cone of reception as indicated in FIG. 3. Finally, system 100 also shows a sensing station 110 that has both a sensing range constraint and a sensing orientation constraint. The sensing range constraint of sensing station 110 is indicated by the finite radius 114 of the cone of the reception of sensing station 110, and its directional constraint is shown by the direction of the cone pointing in the direction shown in FIG. 3.

According to the invention, a set of target sites in workspace 102 represents the locations of interest that are required to be observed. There are sensed stations (not shown) placed at the target sites that are sensed by sensing stations. Preferably, the sensed stations merely represent the sites or locations in workspace 102 that are required to be observed. Such a preferred embodiment is illustrated in FIG. 3, where the target sites comprise the entirety of the interior of workspace 102, notwithstanding obstructions 104. The set of such target sites is represented by X. In other words, X represents the set of all those sites or points in workspace 102 (not including obstructions 104), that are required to be observed by sensing stations 106, 108 and 110.

According to the apparatus and methods of the main embodiments of the present invention, a sensing region exists around each sensing station when that sensing station is at a given site, called candidate site in workspace 102. A candidate site would generally comprise the location information of the sensing station in workspace 102, the type of sensing station (106, 108 or 110) and any other ancillary information that may be needed to be associated with the candidate site. Such ancillary information may include, but is not limited to, the configuration of the sensor including its orientation, its sensing region (as will be taught below), and its any other capabilities or constraints, etc. Note, the invention refers to all the such potential sites where a sensing station can be placed in the workspace as candidate sites, and it refers to that subset of candidate sites where the sensing stations should be placed or deployed in order to ensure coverage, as placement sites. In other words, the set of placement sites or simply placement sites refers to the ‘computed solution’ of the sensor deployment strategy as offered by the instant invention.

The location information of a candidate site may include the two-dimensional or three-dimensional coordinates in a two-dimensional or three-dimensional Euclidean space of the system. The orientation information of a sensing station may include its three axes of orientation with respect to a given coordinate system. The orientation may be represented by rotation matrices Rₓ(∝) for rotation by angle ∝ around x-axis, R_{y}(β) for rotation by angle β around y-axis and R_{z}(γ) for rotation by angle γ around z-axis, or by Euler angles or still by any other rotation convention familiar to people of skill.

Further, a skilled artisan will understand that rigid body rotations are conveniently described by three Euler angles (φ, θ, ψ). Specifically, Euler angles (φ, θ, ψ) describe how body axes (X_{b}, Y_{b}, Z_{b}) originally aligned with the axes (X,Y,Z) of a coordinate system transform after three rotations are applied in a pre-established order. The magnitudes of Euler angles (φ, θ, ψ) define rotation of body axes (X_{b}, Y_{b}, Z_{b}) in the above-defined order. A skilled artisan will also be well versed in alternative rotation conventions and descriptions thereof. These will not be delved into further detail in this specification. For clarity and ease of explanation in the below teachings, we will sometimes use the angle θ with respect to a known axis in two-dimensional space to indicate the orientation of a sensor.

Preferably the location information of a candidate site is represented by (x, y, z) coordinates in three-dimensional Euclidean space, and the orientation of the sensing station is omni-directional, that is, unconstrained. Preferably the location information of a candidate site is represented by just (x, y) coordinates in two-dimensional Euclidean space, and the orientation of the sensing station with respect to an axis of the two-dimensional coordinate system is represented by the angle θ. Preferably the location information of a candidate site is represented by (x, y) in two-dimensional Euclidean space, and the orientation of the sensing station is omni-directional, that is, unconstrained.

Note that when we refer to an unconstrained orientation of a sensing station or characterize its orientation to be omni-directional above, that simply means that the sensing station is able to sense in all directions, irrespective of where it is ‘facing’. In other words, there is no front or back, or top or down, of the sensor. As will be apparent to those skilled in the art, a variety of such omni-directional sensors are commonplace in the industry, such as a 360° omni-directional or panoramic camera or an analogous microphone.

Similar to a candidate site, the location information of a target site may include its two-dimensional or three-dimensional coordinates in two-dimensional or three-dimensional Euclidean space of the system. The orientation information of a sensed station may include its three axes of orientation with respect to a given coordinate system. The orientation may be represented by rotation matrices Rₓ(∝) for rotation by angle ∝ around x-axis, R_{y}(β) for rotation by angle β around y-axis, R_{z}(γ) for rotation by angle γ around z-axis, or by Euler angles or still by any other rotation convention familiar to people of skill.

Preferably the location information of a target site is represented by (x, y, z) coordinates in three-dimensional Euclidean space, and the orientation of the sensed station is omni-directional, that is, unconstrained. Preferably the location information of a target site is represented just by (x, y) coordinates in two-dimensional Euclidean space, and the orientation of the sensed station with respect to an axis of the two-dimensional coordinate system is represented by the angle θ. Preferably the location information of a target site is represented by (x, y) coordinates in two-dimensional Euclidean space, and the orientation of the sensed station is omni-directional, that is, unconstrained.

Similar to a sensing station, when we refer to an unconstrained orientation of a sensed station or characterize its orientation to be omni-directional above, that simply means that the sensed station is able to be sensed from all directions, irrespective of where it is ‘facing’. In other words, there is no front or back, or top or down, of the sensor. Again, as will be apparent to those skilled in the art, a variety of such omni-directional sensors are commonplace in the industry, such as an omni-directional radio transmitter with a dipole antenna.

Referring to FIG. 3, according to the invention, a sensing region or a visibility region, of a sensing station at a given candidate site represents the collection of sites or locations in workspace 102 that can be sensed by that sensing station when that sensing station is placed at that candidate site in workspace 102. More rigorously, a sensing region vₖ(p) around a sensing station located at a candidate site p in workspace 102 represents the collection of target sites b in workspace 102 where a site b ∈ vₖ(p) if a sensed station at site b is able to be sensed by the sensing station despite obstructions 104 in workspace 102.

Still differently put, sensing region vₖ(p) represents the region of workspace 102 around candidate site p in which a sensing station can sense another sensed station. In case of the preferred embodiment depicted in FIG. 3 where sensed stations merely represent the points or locations of interest that are required to be observed in workspace 102, sensing region vₖ(p) of a sensing station at a candidate site p simply represents the region of workspace 102 around a candidate site p which the sensing station can sense or monitor. Specifically, referring to FIG. 3, sensing region vₖ(p) of sensing station 106 is shown by the star-shaped polygon, or omni-directional hatched cones shown as extending from sensing station 106 in all directions. Sensing region vₖ(p) of sensor 108 is shown by the single, directed hatched cone extending upwards from sensing station 108 and sensing region vₖ(p) of sensor 110 is represented by a single hatched cone with length or radius 114 extending from sensing station 110 leftwards.

The invention further defines a sensing range and a sensing orientation as constraints that may apply to a given sensing station. These constraints are typical of the real world sensors available in the industry. For example, while a standard radio receiver can be an omni-directional sensing station with no sensing orientation or directional constraint, in the form of a parabolic dish however, a radio receiver can also be a directional antenna. In the example illustrated in FIG. 3 containing system 100 where target sites are preferably locations or points within workspace 102, omni-directional sensing stations 106 can be a 360° omni-directional panoramic camera, while sensing station 108 can be a standard directional camera such as the one generally used in Closed-Circuit

Television (CCTV) or video surveillance, and sensing station 110 can be a directional infra-red motion sensor with a limited ranged, such as the one used in home alarm systems.

The invention further allows a given sensing station to have multiple sensors on it, each with its own sensing region defined above. Thus according to the foregoing formal definition of a sensing region, a sensing region vₖ(p) around a sensing station located at a candidate site p in workspace 102 represents the collection of target sites b in workspace 102 where b ∈ vₖ(p) if a sensed station at site b is able to be sensed by sensor k of the sensing station despite obstructions 104 in workspace 102. Differently put, a sensing region corresponding to a given sensor on a sensing station when that sensing station is placed at a candidate site represents the collection of sites or locations in workspace 102 that can sensed by that sensor of the sensing station. Of course it is conceivable within the scope of the present invention to have a single complex sensor on a sensing station that has multiple sensing capabilities with multiple sensing regions according to the above definition.

Following directly from above, according to the present invention, a composite sensing region around a sensing station is defined as the collection of the individual sensing regions around that sensing station. As mentioned above, most likely but not necessarily, these individual sensing stations may be due to individual sensors on the sensing station. More rigorously, a composite sensing region v(p) of a sensing station is defined as the collection of all k sensing regions vₖ(p) when the sensing station is at a candidate site p in workspace 102.

Note that for clarity in FIG. 3, the reader may observe that we have only illustrated sensing stations with apparently single sensing regions, however the teachings readily apply to sensing stations with multiple sensing regions as will be obvious to skilled artisans. Thus equivalently, sensor 106 in FIG. 3 can be thought of as composed of multiple directional sensors facing in different directions, and thus under this assumption sensor 106 has multiple sensing regions, and its composite sensing region is the one illustrated by the omni-directional hatched cones in FIG. 3.

Recall that set X of target sites represents the collection of all points of interest or targets sites that are required to be observed. Recall also that the present invention allows for the placement of sensed stations at such target sites such that the sensed stations are able to be sensed by sensing stations placed at candidate sites. Also recall, in the present embodiment shown in FIG. 3, the sensed stations just represent the locations or target sites in workspace 102 that are required to be observed, and the set X of target sites in FIG. 3 represents the entirety of the interior of workspace 102 that we are interested in observing despite obstructions 104.

According to the invention, there is a set family [symbol] comprising a set of ranges. Note, that following the standard practice of set theory, we are using the well-established term ‘range’ here to describe subsets of set X as will be further taught below. The term range from set-theory here is not be confused with the transmission range or reception range of a sensor. This unfortunate coincidence of reuse of the term in two different fields is unavoidable and any skilled artisan will be expected to understand the different notions of a ‘range’ as applied to set theory and sensors as obvious from the context in below teachings.

Each range in the set family [symbol] of ranges corresponds to a given candidate site and represents the subset of target sites from set X that are able to be sensed by a given sensing station when that sensing station is placed at that candidate site. Recall from earlier teachings that a candidate site comprises the location information of sensing station in workspace 102, the type of sensor or sensing station deployed, and any other ancillary information about the sensing station. Thus each range in set family [symbol] corresponds to a given sensing station and represents a collection of target sites from set X that are able to be sensed by that sensing station when that sensing station is at the candidate site corresponding to that range in set family [symbol] .

The reader is encouraged to note, that the sensor deployment strategy offered by the present invention provides an effective mechanism to deploy a variety of different ‘types’ of sensors, a distinction over prior art. Thus it is sufficient for a range to be defined as per the above definition for each type of sensing station available in system 100, in our case omni-directional sensors with no range constraint such as sensor 106, directional sensors with no range constraint such as sensor 108 and directional and range constraint sensors such as sensor 110.

More formally, according to the invention, there is a set family of ranges [symbol] ={R₁, R₂, . . . , Rₘ} whose union is the set X of all target sites, where Rᵢ is the subset of set X of those target sites that are able to be sensed by that sensing station (or that type of sensing station as per above) when it is at a candidate site pᵢ in workspace 102. From here onwards, we will generally drop the distinction between individual sensing stations and individual types of sensing stations to reduce repetition in the following explanation, and will only refer to the ranges being defined for each sensing station, with the knowledge that this implies defining the ranges for each type of sensing station. However as needed, we may distinguish the sensor types by their reference numerals 106, 108, 110 in the ensuing explanation.

The sensor deployment system 100 of FIG. 3 then determines the deployment strategy for deploying sensing stations 106, 108, 110 in workspace 102 by determining a minimum set-cover for set system Σ={X, [symbol] }. Explained further, sensor deployment system 100 of the present invention determines a set of placement sites from the overall set of candidate sites {p₁, p₂, . . . , pₘ} for the placement of sensing stations 106, 108, 110 in workspace 102 to ensure coverage of the entirety of workspace 102 (excluding obstructions 104) such that any target site or point in workspace is sensed by at least one sensing station, by finding a minimum set-cover for the set system with the ground set as set X and ranges given by set family [symbol] . Note that the cardinality of set [symbol] is the same as the cardinality of the set of all candidate sites {p₁, p₂, . . . , pₘ}. In other words, there is a 1-to-1 correspondence between each candidate site, and what subset of set X (or the range), a sensing station at that candidate site can sense.

Those skilled in the art will understand that finding a minimum set-cover is an NP-hard problem. However a Greedy algorithm based solution is a popular approach to finding a near-optimal solution in polynomial time. Therefore, the minimum set-cover is preferably derived using the Greedy algorithm solution. Given sensor deployment system 100 of FIG. 3, with the set family [symbol] ={R₁, R₂, . . . , Rₘ} of ranges as explained above and the set X of all target sites, the Greedy solution can be implemented using the following pseudo-code:
10: Set set-cover C=Ø
20: Find set R ∈ [symbol] with the largest cardinality
30: Remove set R from [symbol]
40: Set C=C ∪ R
50: Delete contents of set R from set X
60: If X≠Ø
   70: Goto 10
80: Else
   90: Retrieve candidate sites corresponding to the ranges in C as the placement sites, or the computed solution
   100: Stop
110: Fi

It will be apparent to those skilled in the art how to implement or code the above popular algorithm using the appropriate data structures and other software programming constructs. Those details are well understood by skilled artisans and will not be delved into detail in this specification. For example, one approach is to store the target sites visible from a sensing station in the data structure associated with the candidate site where the placement of the sensing station is being considered, as explained earlier in reference to ancillary information associated with a candidate site. Based on the contents of this data structure, it is easy to define the ranges with respect to each candidate site and sensor, to implement the above algorithm in any programming language of choice.

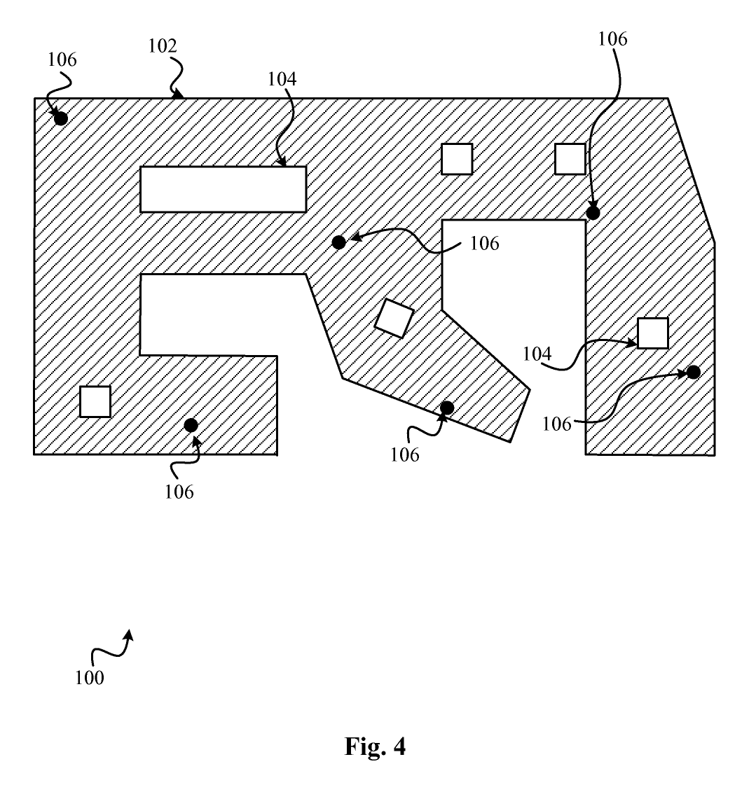

Such a solution derived by the above Greedy algorithm representing a sensor deployment strategy for system 100 is illustrated in FIG. 4. Recalling that set X representing all target sites was chosen to be the entirety of the interior of workspace 102, FIG. 4 represents the distribution of various types of sensor that will near-optimally provide coverage for the entirety of the interior of workspace 102, despite obstructions 104. Note that since sensing station 106 is unconstrained both in direction and range, Greedy algorithm has only chosen sensing stations of this type in the solution represented in FIG. 4.

This is because the Greedy algorithm in each iteration will choose the range with the largest cardinality (as shown in above pseudo-code), and hence will always favor the range corresponding to the most far-reaching or encompassing sensor, in our case sensor of type 106. Note also, that for clarity, FIG. 4 does not explicitly show the individual sensing regions of the sensors separately, but rather collectively represents the interior of workspace 102 (excluding obstructions 104) as covered by the sensors by the hatched pattern shown.

It will be obvious to those skilled in the art that a set-cover solution in computational geometry represents the minimum set of ranges that cover the entire ground set, in our case set X of all target sites. However such a solution is not unique in the sense that more than one solutions may exist that offer the same near-optimal deployment of available sensors. In other words, referring to our example and the solution offered in

FIG. 4 there may be more than one set of placement sites from the set of candidate sites {p₁, p₂, . . . , pₘ} that cover the entirety of the interior of workspace 102 and also use six sensors of type 106.

In computational geometry, a sampling is an arrangement of points in the space chosen randomly, pseudo-randomly, along a regular grid, etc. Indeed through sampling a geometric problem is easily converted into a finite set system. Note that in our earlier example we were interested in observing all the sites or points within workspace 102 (excluding obstructions 104). However such is not always the case. In fact, very often it is desired to discretely sample a workspace such that there are a finite number of discrete points that comprise candidate sites {p₁, p₂, . . . , pₘ} and ground set X. Note that using the norms of computational geometry we are referring to our set X of all target sites in workspace 102 from FIG. 3 and FIG. 4 as the ground set. Such a choice of terms will be apparent to those skilled in the art.

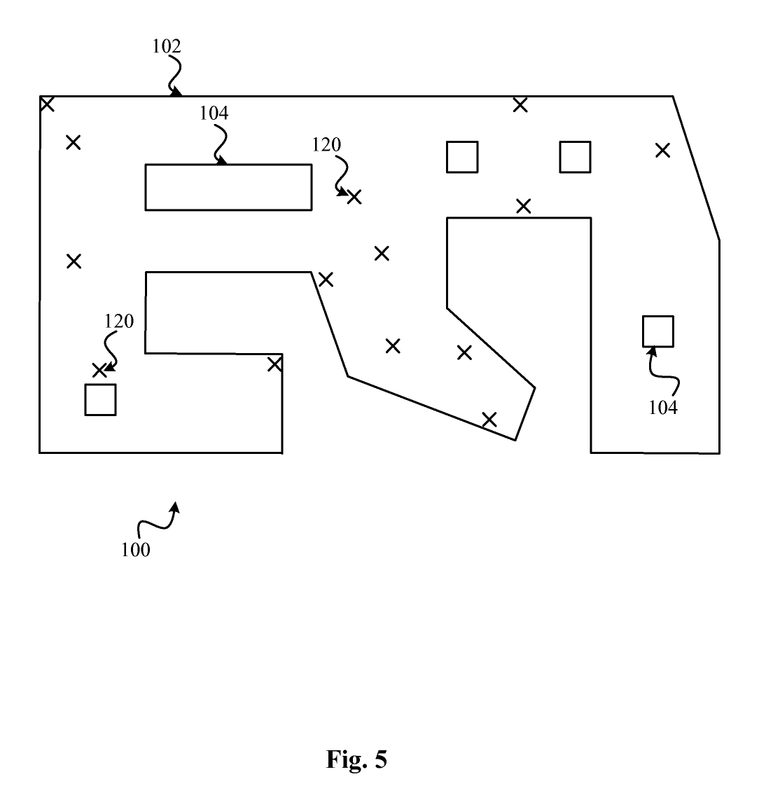

FIG. 5 represents workspace 102 that has been discretely sampled into a handful of points represented by ‘X’es in FIG. 5. Note also in FIG. 5 that for clarity we have only used reference numeral 120 to indicate two such sampled points or ‘X’es. Thus in the associated embodiment of the invention that utilizes a sampled workspace, it will be only required to observe points 120 marked by ‘X’es in workspace 102 as shown in FIG. 5, by the computed placement sites, rather than the entirety of the interior of workspace 102 (excluding obstructions).

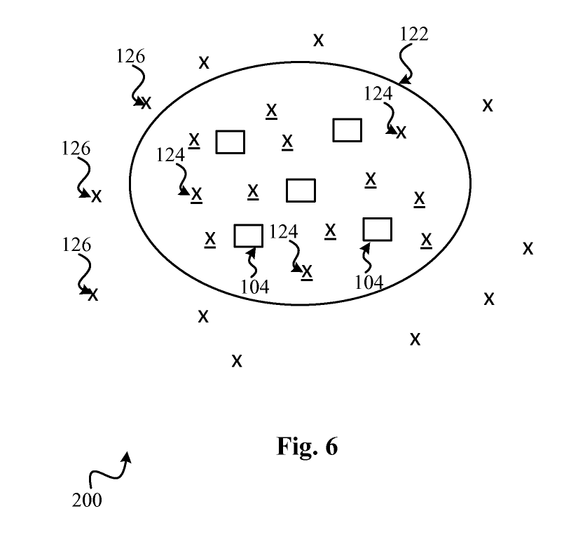

It should be noted that in the preferred embodiment explained above candidate sites {p₁, p₂, . . . , pₘ} and ground set X are overlapping, that is, a candidate site can also be target site or vice versa. However, in an alternative embodiment of the invention, candidate sites and target sites do not overlap. Such a situation is expected when there is a set of locations, such as walls or ceilings for sensing stations, and there are points or locations of interest on the floor or other parts of the building that are required to be observed. FIG. 6 represents such a scenario where oval shape 122 represents a region of interest 122 containing target sites 124 while candidate sites 126 exist outside of region of interest 122 and are non-overlapping with target sites 124. Note again, that for clarity we have labeled only three candidate sites by reference numeral 126 indicated by crosses ‘X’ and only three target sites by reference numeral 124 indicated by ‘X’ (underlined).

Now we will look at a variation of the embodiment explained earlier with the added constraint that placement sites for a certain type of sensor can only be chosen from a set of sampled points or a placement region and that only a certain quantity of certain types of sensors are available. Such constraints are commonplace in real environments where cameras and other sensors are available in limited quantity and they can only be placed at appropriate locations in a workspace, such as walls and ceilings of a certain height, shape, construction, etc. Such a scenario is represented in FIG. 7 where unconstrained omni-directional sensors 106 of FIG. 3 can only be deployed or placed in placement regions 310 indicated by dot and dashed lines, directional but range-unconstrained sensor 108 of FIG. 3 can only be deployed or placed in placement region 312 indicated by dashed line, and directional and range-constrained sensor 110 of FIG. 3 can only be deployed or placed in placement region 314 indicated by double dot and dashed line.

Let us further impose the constraint that five sensors of sensor type 106 are available, and one sensor each of types 110 and 112 are available. Indeed the capability to incorporate such constraints as to where potential candidate sites can be located and how many sensors of a given type can be used, represents one of the highly preferred embodiments of the present invention.

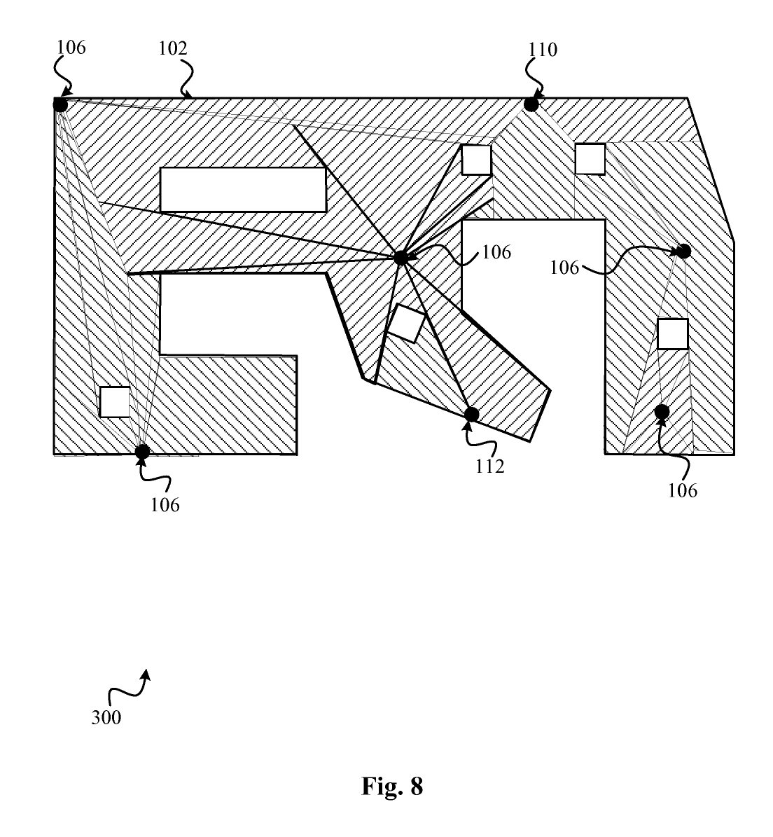

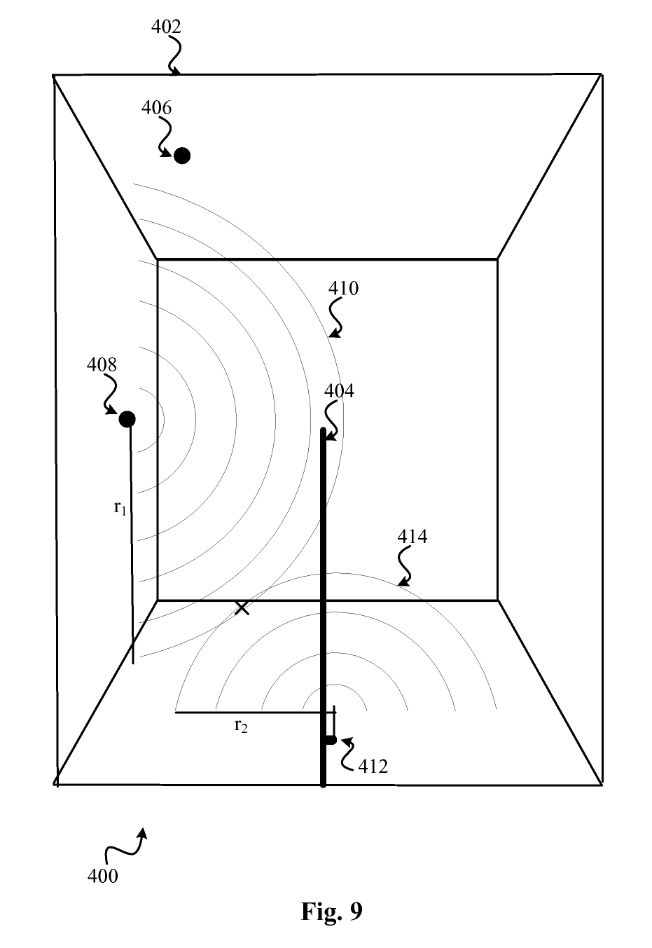

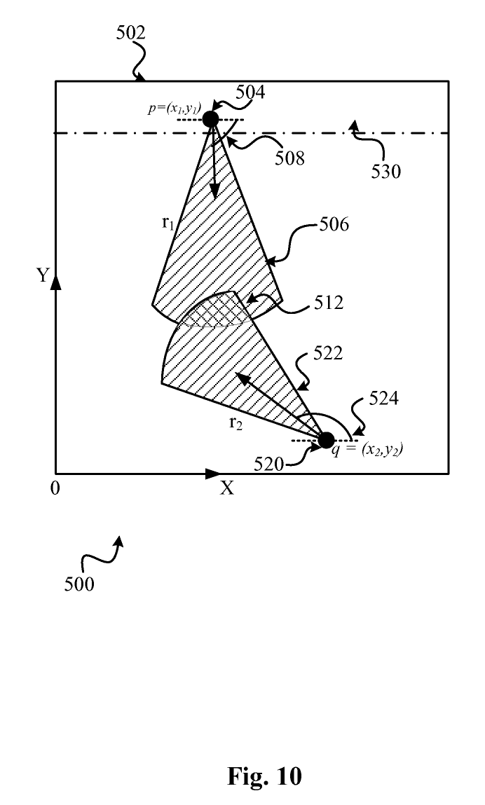

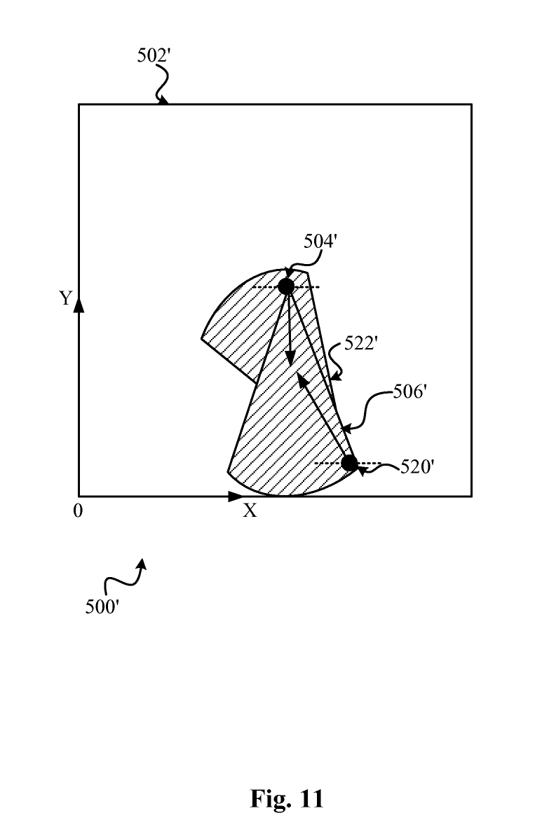

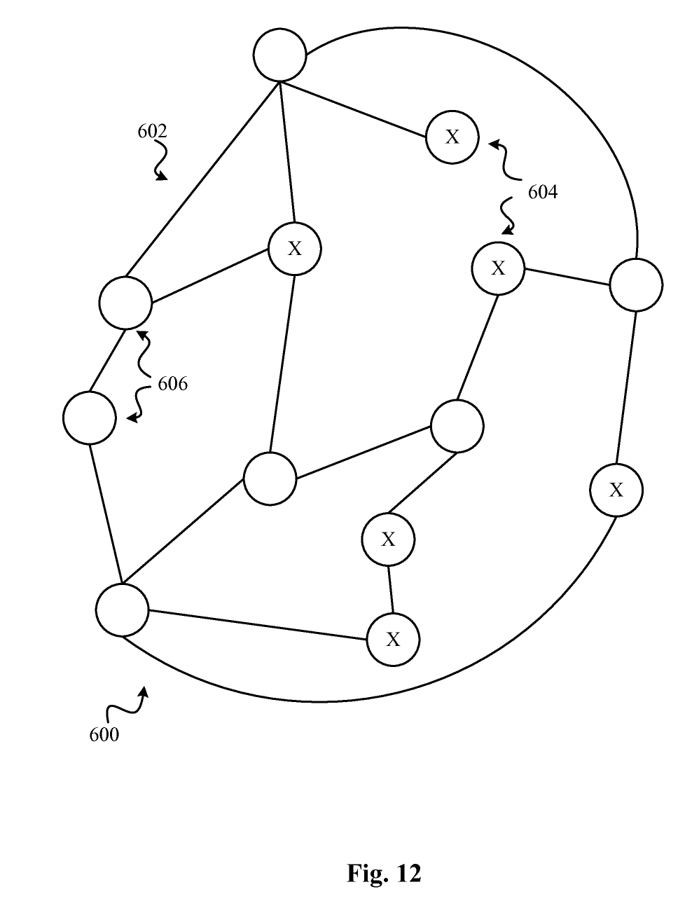

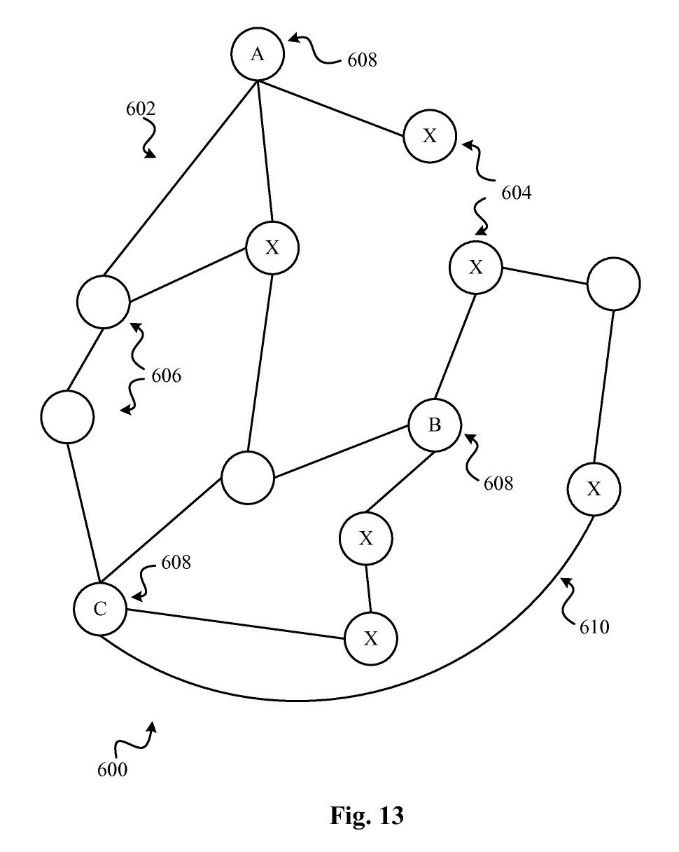

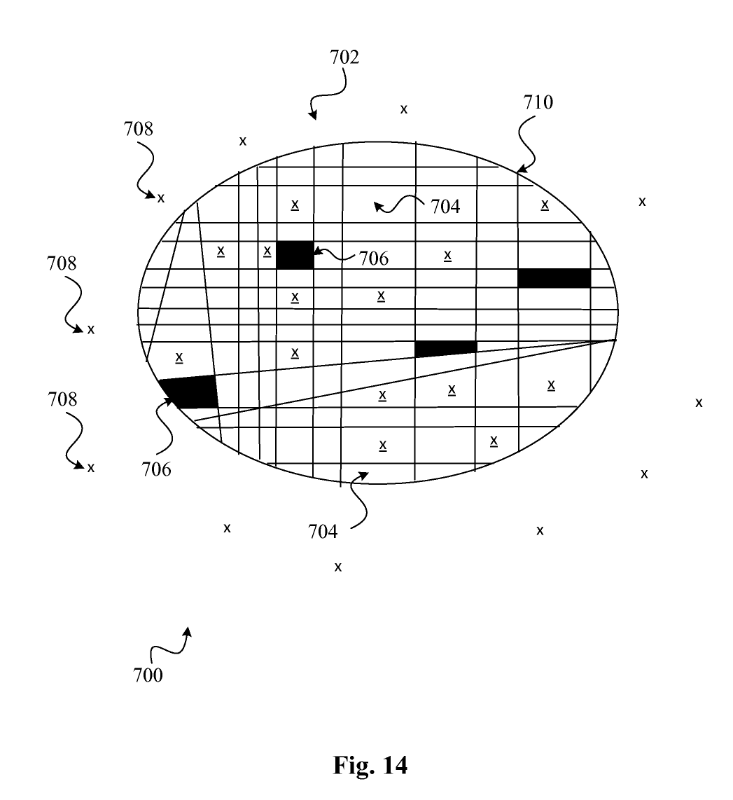

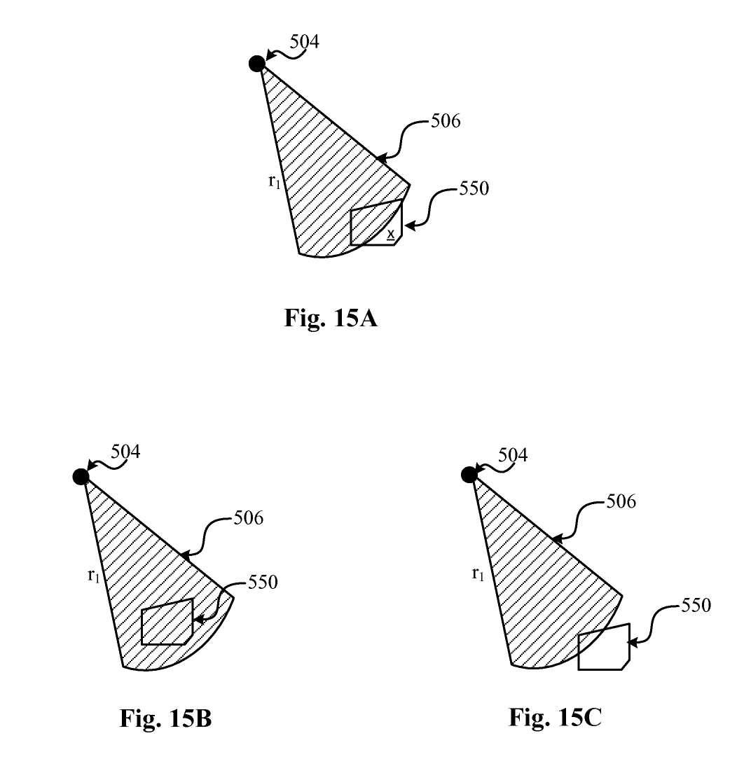

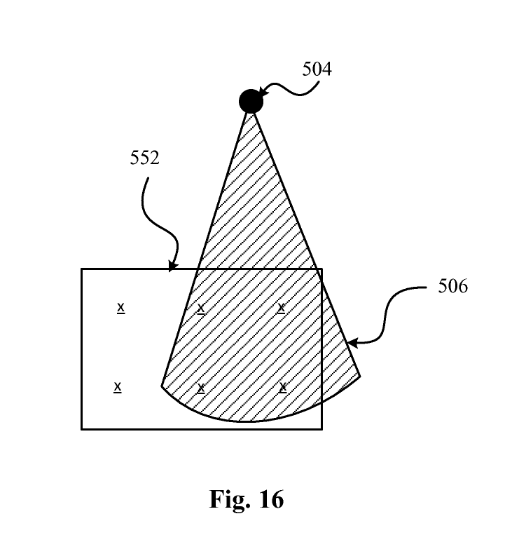

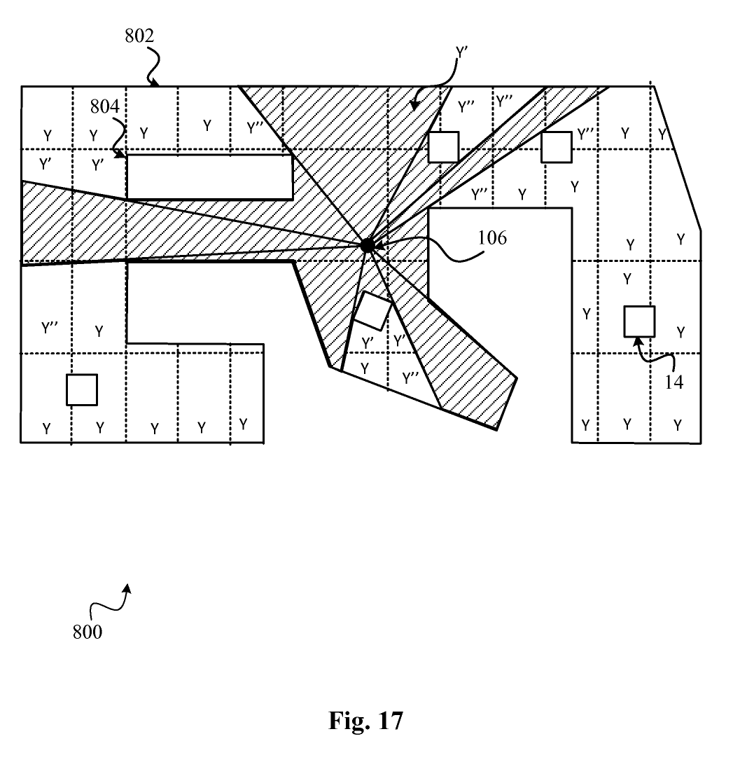

Based on a variation of the Greedy algorithm presented above, FIG. 8 represents a solution derived by the present invention. Note that the algorithm has determined the placement sites for the five available sensors of type 106 in placement regions 310 for sensor 106 as required, it has determined the candidate site for sensor 110 in placement region 312 of sensor 110 as required, and further the algorithm has placed a sensor 112 that is both directional and range-constrained to cover the remainder uncovered region 314 as indicated in FIG. 8. Note also that for clarity, FIG. 8 explicitly shows the sensing regions of the various sensors represented by hatches, as they cover various parts of workspace 102. Note also, that for clarity we have omitted placement regions 310, 312, 314 of FIG. 7, from FIG. 8, but the reader is invited to confirm that the computed solution illustrated in FIG. 8 indeed satisfies the constraints of the placement regions.

Now we will look at the changes or variations to the Greedy algorithm presented above, that are required to enable this embodiment having constraints on the placement and quantities of sensors. Note that in as far as the constraint requiring the placement of the sensing stations at predetermined locations or placement regions, this constraint is easily satisfied by the selection of candidate sites {p₁, p₂, . . . , pₘ} in the first place. In other words, we will only pick candidate sites that satisfy the placement constraints of the problem i.e. candidate sites within placement regions 310, 312, 314 (see FIG. 3, FIG. 7) for sensors 106, 108, 110 respectively.

As far as satisfying the constraint of predetermined quantities of various types of sensors, the Greedy algorithm above can be modified to include a ‘tally’ for each type of sensor. During each iteration of the algorithm shown, before choosing a range the algorithm will first check if the tally for the corresponding sensor is greater than zero. Once it picks the range with the largest cardinality, it will also decrement the tally of the corresponding sensor. If the tally reaches zero, the algorithm will stop choosing ranges corresponding to that sensor in subsequent iterations. Once all tallies have reached zero, the algorithm will terminate, whether or not a full cover has been computed. Note that this will be a ‘best-effort’ variation of the popular Greedy algorithm presented by the pseudo-code earlier. Such a best-effort algorithm will not guarantee that the computed solution will cover the entire ground set X, and may only provide a partial cover. Indeed the solution illustrated in FIG. 8 shows an execution scenario, where the algorithm has computed a full cover.

As taught above, preferably the minimum set-cover that forms the basis of the sensor deployment strategy of the present invention is based on the familiar Greedy algorithm. In the preferred embodiment, the minimum set-cover determined by the present invention is found in polynomial time. Those skilled in the art will know that Greedy algorithm gives an approximation ratio that is bounded by (1+logR_{L}), where approximation ratio is defined as the size of the computed cover C divided by size of the optimal cover C* i.e. |C|/|C*|, and R_{L} is the range set with the largest cardinality in set family [symbol] . The Greedy algorithm is effective for applications where the size of set R_{L} i.e. |R_{L}| is a small fraction of the size of ground set X i.e. |X|.

An alternative algorithm is the one proposed by Bronnimann and Goodrich in “Almost optimal set covers in finite VC-dimension” (1995). Using this approach, given our set system Σ={X, [symbol] } above having a VC-dimension of d and using the familiar Big-O notation, there is a polynomial-time algorithm for finding a set cover with size at most a factor [symbol] (d log dC*) from the optimal size C*. Note that this bound does not explicitly depend on the cardinality of set X or the largest set in [symbol] . Preferably, the solution used to determine the minimum set-cover as taught by the present invention is of size at most a factor [symbol] (d log dC*) from the optimal size C*. Still preferably, the VC-dimension d above is bounded by [symbol] (log h) where h represents the number of obstructions, such as those represented by reference numeral 104 in FIG. 3-8. Those skilled in the art will recognize that there can be any number of algorithms including the ones described above that may be employed to solve for the minimum set-cover as the basis for the sensor deployment strategy provided by the present invention.

Recall from earlier teachings that the instant invention allows a given sensing station to have multiple sensors on it, each with its own sensing region as defined above. Specifically recall that there are k sensing regions vₖ(p) around a sensing station located at a candidate site p and that there is a composite sensing region v(p) of the sensing station as a collection of all k sensing regions vₖ(p) when the sensing station is at candidate site p in the workspace.

Such a collection of individual sensing regions vₖ(p) can preferably be a union of the individual sensing regions vₖ(p) to form the resultant composite sensing region v(p) i.e. v(p)=∪ᵥ_{ₖ}₍ₚ₎. This scenario is readily conceivable in an application where a sensing station may have multiple types of receivers and the objective is to determine a heartbeat of a sensed station or a target site without caring which sensor it comes from. For example if the sensed station is a short-range radio device that emits radio frequencies, and the objective of the application is to ensure that the device is present, then the sensing station equipped with a camera and a radio receiver may be employed. As long as there is a visual confirmation from the camera on the sensing station or the reception of the short-range radio signal the objective of determining the presence or the absence of the radio device is achieved.

In an alternative embodiment the above collection of individual sensing regions vₖ(p) can preferably be an intersection of the individual sensing regions vₖ(p) to form the resultant composite sensing region v(p) i.e. v(p)=∩ᵥ_{ₖ}₍ₚ₎. Again, such a scenario is easily conceivable in an application where a positive confirmation from multiple sensors has to be obtained for the objectives of the application. Using our example above, if the requirements to ascertain the presence or absence of the short-range radio device in question are such that not only the short-range radio signal has to be received, but also a visual confirmation of the blinking lights on the radio device in sync with the reception of the radio signal is also required, then the intersection operation of the individual sensing regions will be the right approach to form composite sensing region v(p).

Indeed in yet another preferred embodiment, the invention allows for a generic set operation to be performed on the individual sensing regions to form the resultant composite sensing region as may be required for a given application. Continuing our example above, if a third sensor on the sensing station is a microphone, then a positive confirmation of the presence of the short-range radio device may be obtained by the following definition of the composite visibility region of the sensing station: v(p)=((v_{radio} ∪ v_{audio}) ∩ vᵥᵢₛᵤₐₗ)(9) i.e. either a radio or audio signal would suffice, as long as it is obtained with a visual confirmation. To conclude this discussion, and as previously mentioned, it is entirely conceivable within the scope of the instant invention to have a single complex sensor on a sensing station that has multiple sensing regions vₖ(p), for example, an Audio-Visual camera equipped with a lens and a microphone.

In a highly preferred embodiment, the present invention uses sensed stations located at the target sites. FIG. 9 illustrates such an embodiment as sensor deployment system 400 in a 3-D perspective view. System 400 has a workspace 402 and a visual obstacle or a wall 404. There is a sensing station 406 which can be a ceiling camera. System 400 also has a radio sensing station 408 attached to a wall. Sensing station 408 has a radio sensing region 410 which is omni-directional in workspace 402 but with a finite range as indicated by radius r₁. There is a sensed station 412 on the other side of wall or obstruction 404. An exemplary sensed station 412 can be a short-range radio transmitter as indicated by the transmitting antenna shown.

According to the instant invention, sensed region or visibility region of a sensed station at a target site represents the collection of sites or locations in a workspace that reveal the sensed station to a sensing station when that sensing station is placed at a candidate site in the workspace and there is some overlap between the sensing region of the sensing station and sensed region of the sensed station. More rigorously, a sensed region μₗ(q) around a sensed station located at a target site q ∈ X in a workspace represents the collection of sites c in the workspace such that the sensed station is able to be sensed by a sensing station at a candidate site p if site c is also in sensing region vₖ(p) of the sensing station despite the obstructions in the workspace.

Still differently put, a sensed region around a sensed station located at a target site q represents the collection of sites in the workspace that in case of any overlap with a sensing region of a sensing station location at a candidate site p will result in the sensed station being sensed by that sensing station. Of course, it follows directly from the above teachings that a composite sensed region μ(q) for a said sensed station at a target site q will be a collection of all individual l sensed regions μₗ(q) when the sensed station is at the target site q ∈ X in the workspace. Indeed as in the case of sensing regions, a composite sensed region μ(q) around a sensed station as a collection of individual sensed regions μᵢ(q), may be a union of individual sensed regions μₗ(q) i.e. μ(q)=∪_{μ}_{ₖ}(ₚ), an intersection of individual sensed regions μₗ(q) i.e. μ(q)=∩_{μ}_{ₖ}₍ₚ₎, or it may be based on a generic set operation performed on individual sensed regions μₗ(q).

Similar to a sensing station, the individual l sensed regions μₗ(q) when the sensed station is at a target site q ∈ X in the workspace may be as a result of the individual sensed regions of the various sensors present on the sensed station. The reader will observe that the teachings in reference to a composite sensing region v(q) of a sensing station and the various application scenarios, also easily extend to a composite sensed region μ(q) of the sensed station. In other words, as an example, it is easily conceived within the scope of the present invention to require a sensed station to either send a visual confirmation, or an audio and radio signals together to a sensing station. To satisfy these requirements, the composite sensed region μ(q) of a sensed station may be defined as: μ(q)=((μ_{radio} ∩ μ_{audio}) ∪ μᵥᵢₛᵤₐₗ)(q).

Preferably, sensed region μₗ(q) around each sensed station when said sensed station is at said target site q ∈ X in a workspace is further defined such that a sensing station at candidate site p with sensing region vₖ(p) is able to sense the sensed station, if p is in sensed region μₗ(q) and q is in sensing region vₖ(p). Such an embodiment further tailors the application of instant invention to scenarios with more restrictive communication regimes, that is, where in order for a sensor to be sensed by another sensor, both sensors have to be within the sensing/sensed regions or fields of communication of each other, rather than merely having an overlap of their respective communication fields or radiation patterns.

Armed with the above definitions, let us return to FIG. 9. Note that sensed station 412 has an omni-directional sensed region 414 in workspace 402. Further, sensed region 414 has a finite sensed range as indicated by radius r₂. Further note, that there is an overlapping region 416 as indicated by a cross ‘X’ that intersects both sensing region 410 of sensing station 408 and sensed region 414 of sensed station 412. Consequently, sensed station 412 will be able to be sensed or detected by sensing station 408 in system 400. Note however, that because of wall 404 which poses no obstacle to radio waves but is a visual obstruction, ceiling camera 406 will not be able to detect sensing station 412.

In a very highly preferred embodiment of the present invention, target sites are not merely locations or points in a workspace, but sensed stations or smart sensors, with their own sensed regions according to above explanation. This unique capability of the present invention, allows the sensor deployment based on minimum set-cover as taught above to be applied to a variety of interesting applications in a number of industry verticals that have requirements to observe and detect not just passive parts of a geography or ‘locations’ of interest, but rather monitor active devices with their own smart transmission capabilities and their own unique configuration and characteristics.

FIG. 10 represents such a relevant scenario having a sensor deployment system 500 according to the present invention. Note again that system 500 is represented in a two-dimensional form for clarity of illustration, but as in all other embodiments of the invention, the teachings directly extend to a three-dimensional, or even a higher-dimensional environment. In fact the sensors and cones represented in FIG. 10 can be construed as a two-dimensional planar cross section of the corresponding 3-D frontal view. System 500 has a sensing station 504 that needs to be deployed in the two dimensional Euclidean space indicated by the X and Y axes.

As taught earlier, candidate site(s) of the current invention comprise the location information of sensing station 504 in workspace 502, and any other ancillary information that may be needed to be associated with sensing station 504. Such ancillary information may include, but is not limited to, the type of the sensor, its configuration, orientation, sensing region, etc. In the preferred embodiment shown in FIG. 10, sensing station 504 has both an orientation constraint of its sensing region 506 as indicated by angle 508 and a range constraint as shown by radius r₁ of its conical sensing region.

Similarly, system 500 also has sensed station 520 located at target site q at coordinates (x₂, y₂) with respect to the X,Y coordinate system shown, and has a sensed region 522 with an orientation constraint indicated by angle 524 as shown and a range constraint indicated by radius r₂ of its conical sensed region 522. As per earlier embodiments, target site q represents the area of interest that is required to be observed by system 500 using sensing station 504.

Now let us place a further constraint on system 500 that sensor 504 can only be deployed within placement region 530 indicated in FIG. 10. Using the above teachings of the present invention we compute the solution for a minimum set-cover to determine where to deploy sensing station 504 within the existing constraints. One such solution is shown in FIG. 10. Specifically, the algorithm of the invention determines the deployment location of sensing station 504 to be the placement site with location coordinates (x₁, y₁) as indicated in FIG. 10. Note that the solution is based on determining whether sensed station 520 can be sensed by sensing station 504 based on their respective sensed region μₗ(q) and sensing region vₖ(p) as taught earlier.

Recall that in a preferred embodiment, sensed station 524 can be sensed by sensing station 504 if there is some overlap between their respective sensed and sensing regions. This overlap is indicated by reference numeral 512 in FIG. 10. Further note, that location coordinates (x₁, y₁) merely represent one such solution since there are other locations within placement region 530 that would satisfy the requirement of sensed station 520 able to be sensed by sensing station 504. Explicitly, locations in the immediate vicinity to the right and left of location coordinates (x₁, y₁) will also be valid solutions. As stated earlier, that there may be other ancillary information besides location coordinates (x₁, y₁) associated with the placement site with location coordinates (x₁, y₁). Note that a placement site is simply a candidate site chosen by the algorithm of the invention in the computed solution where a sensing station should be placed or deployed. As will be apparent to the reader by now, the above example is easily extended to include multiple locations of interest q and multiple sensing stations of varying capabilities.

Another preferred embodiment requires that the set of placement sites to be computed are such that each sensed station is able to be sensed by at least two sensing stations. This capability enables the invention to perform triangulation to determine the location of a sensor or sensed station. If each sensing station is covered by three sensing stations, then another technique called trilateration can be performed to determine the location of a sensor or sensed station. We refer to the capabilities of performing triangulation or trilateration as ‘localizability coverage’ of the present invention.

Those skilled in the art will understand the basic mechanism of triangulation for determining the location of a point by measuring angles to it from known points at the two ends of another fixed baseline. The point can then be fixed as the third point of a triangle with one known side and two known angles ∝ and β. The accuracy of triangulation is heavily dependent on the lesser of these two known angles, which we assume is ∝ in the present discussion. It is therefore of great interest to compute ‘two-guarded’ covers that guarantees ∝>∝′ for all target sites, where ∝′ is a minimum performance criterion for the triangulation being performed for the particular situation at hand.

In “Approximation Algorithms for Two Optimal Location Problems in Sensor Networks”, Efrat et al. of University of Arizona, Tucson (2005) proves that if a ‘two-guarded’ cover with minimum angle ∝′ exists, and given a set-cover G₁ computed to provide standard ‘single-guard’ coverage, then any target site in set X of target sites can be ‘two-guarded’ or sensed by two sensing stations by choosing one placement site from G₁ and the second placement site from a second computed set-cover G₂. The second set-cover G₂ is guaranteed to exist and its computation can be decoupled from the computation of the first set cover G. The result is a ‘two-guarded’ coverage albeit with the performance criterion of ∝′/2.

Such an approach can be easily implemented using the current invention by computing a set of placement sites or the first cover as in the main embodiment, and then performing a second pass by first removing the original set of placement sites from the available candidate sites {p₁, p₂, . . . , pₘ} and computing a second cover or set of placement sites to obtain the ‘two-guard’ solution as taught in Efrat et al. Such a two-guard solution will provide at least two placement sites that can sense each sensed station, and hence can be used to triangulate the position of any sensed station in the workspace (provided the observation angle is satisfactory for the requirements). Similarly, within the scope of the invention and using above techniques, one can compute a ‘three-guard’ solution of the target sites in set X to be able to trilaterate the position of any sensed station. Those skilled in the art will be familiar with the mechanism of trilateration using three known positions and will know that good trilateration is achieved when each sensed station is contained inside some triangle formed by three sensing stations.

Recall the earlier definition of a sensing region vₖ(p) around a sensing station at a candidate site p as the region in which the sensing station can sense a sensed station. Also recall the earlier definition of a sensed region μ(q) at a target site q around a sensed station as the region which if it intersects with a sensing region of a sensing station will result in the sensed station being sensed by the sensing station. We will refer to such coverage as ‘sensing coverage’. A highly preferred set of embodiments of the invention expand the above capabilities of sensing coverage to include the ability to communicate and not just sense. Consequently we will refer to such coverage as ‘network coverage’. Obviously network coverage implies sensing coverage.

Such communication can take a number of different forms including but not limited to sending and receiving messages that may contain just ‘pings’ or data payload, sending and receiving different types of electromagnetic radiation patterns to mean different things, sending and receiving different types or strengths of electrical signals to mean different things, sending and receiving different types or strengths of audio signals to encode different meanings and varying any characteristic of a physical signal to encode messages, etc.

Let us address the expanded definition of a sensing region of the current invention under network coverage more precisely. To enable network coverage, sensing region of a sensing station at a given candidate site represents the collection of sites or locations in the workspace where the placement of a sensed station will enable the sensing station to communicate with that sensed station. More rigorously, a sensing region vₖ(p) around a sensing station located at a candidate site p in a workspace represents the collection of target sites b in the workspace where target site b ∈ vₖ(p) if the placement of a sensed station at site b will allow the sensing station to be able to communicate with the sensed station despite the obstructions in the workspace. Further, a composite sensing region v(p) of the sensing station is a collection of all such k sensing regions vₖ(p) when the sensing station is at candidate site p in the workspace. Still further, such a collection can be a union of all such k sensing regions vₖ(p) i.e. ∪ᵥ_{ₖ}₍ₚ₎, an intersection i.e. ∩ᵥ_{ₖ}₍ₚ₎, or it can be based on a generic set operation on sensing regions vₖ(p).

Similarly, let us address the expanded definition of a sensed region of the current invention under network coverage more precisely. To enable network coverage, sensed region of a sensed station at a target site q in a workspace represents the collection of sites or locations in the workspace that in case of an overlap with a sensing region vₖ(p) of a sensing station at a candidate site p, will enable the sensed station to communicate with the sensing station. More rigorously, a sensed region μₗ(q) around a sensed station located at a target site q ∈ X in a workspace represents the collection of target sites c in the workspace such that the sensed station is able to communicate with a sensing station at a candidate site p if c is in sensing region vₖ(p) of the sensing station, despite the obstructions in the workspace.

Preferably, sensed region μₗ(q) around each sensed station when said sensed station is at said target site q ∈ X in a workspace is further restricted such that the sensed station is able to communicate with a sensing station at candidate site p with sensing region vₖ(p), only if p is in sensed region μₗ(q) and q is in sensing region vₖ(p). Such an embodiment further tailors the application of instant invention to scenarios with more restrictive communication regimes, that is, where in order for a sensor to communicate with another sensor, both sensors have to be within the sensing regions or fields of communication of each other, rather than merely having an overlap of their respective communication fields or radiation patterns.

FIG. 11 shows a variation of sensor deployment system 500 of

FIG. 10, with the more restrictive definition of sensing and sensed regions above under sensing coverage or network coverage. Specifically, for sensor deployment system 500′ of FIG. 12 with workspace 502′, in order for sensed station 520′ to be sensed by sensing station 504′ or to communicate with it, sensed station 520′ has to be in sensing region 506′ of sensing station 504′, and sensing station 504′ has to be in sensed region 522′ of sensed station 520′ as shown.

Further, a composite sensed region μ(q) of the sensed station is a collection of all such l sensed regions μₗ(q) when the sensed station is at target site q in the workspace. Still further, such a collection can be a union of all such l sensed regions μₗ(q) i.e. ∪_{μl(q)}, an intersection i.e. ∪_{μl(q)}, or it can be based on a generic set operation on sensed regions μₗ(q). Obviously there are many applications of network coverage as enabled above in the real world. From monitoring pets with radio collars that need to communicate the identification number of the pet and location back to the owner, to babies with Radio Frequency Identification (RFID) bracelets, to toll stations such as bridges reading toll tags in vehicles, to name a few.

In the preferred embodiment of the invention the sensing stations and the sensed stations of the present invention are wireless devices that operate substantially in the 60 GHz range. Those skilled in the art will agree that 60 GHz frequency range is poised to become the next big frequency in the world of wireless devices, with both short-range and wider area applications. The frequency is part of the ‘V-Band’ frequencies in the United States and is considered among the millimeter radio wave (mmWave) bands. Its applications will include broad range of new products and services, including high-speed, point-to-point wireless local area networks and broadband internet access. High Definition Wireless (WirelessHD) is another recent technology that operates substantially near the 60 GHz range. A key characteristic of this frequency range is that its highly directional, ‘pencil-beam’ signal characteristics permits different systems to operate close to one another without causing interference. The upcoming Wi-Fi standard IEEE 802.11ad is also slated to run in this frequency range.

In another preferred embodiment of the instant invention, the workspace is a video, whether realtime or near-realtime streaming video or pre-recorded footage. In this interesting embodiment the applications include finding a scene in the video that would cover a desired place, such as a geographical location in an urban or sub-urban environment, a building, or a specific room in the building. Examples of such an application are in video editing where the director and video editor are interested in ensuring that a certain part of the set, such as a house or the living room of the house, is adequately covered in the final edited footage that was originally taken by a number of different cameras from different locations. Alternatively, a criminal investigation may be concerned with ensuring that a certain event that had transpired is as fully covered by the available footage from passerbys and security cameras on the surrounding building as possible. The present invention provides such a capability by mapping the sensing stations to be the cameras with their associated timelines, the workspace to be the entire footage, and the points of interest to be the place, event or the scene that needs to be covered.

In a similar embodiment of the present invention, the sensing stations are persons, sensed stations are other persons, the workspace is a given geographical area while the candidate and target sites comprise the location coordinates in the geographical area. In a related embodiment, the sensing stations or sensed stations are other objects of interest, and not necessarily human beings. Of course, many applications fitting such embodiments are easily conceived. An example use-case for such an embodiment is ensuring that celebrities (sensed stations) at the Academy Awards ceremony or The Oscars at Dolby Theater in Hollywood (workspace) are adequately covered by NBC videographers (sensing stations). Another example could be vehicles in a parking lot or a transportation hub that need to be tracked by sensors, etc.

In yet another set of highly preferred embodiments of the present invention, a social graph is treated as the workspace. With the ubiquitous presence of social networking communities such as Facebook, LinkedIn, Google+, MySpace, Instagram, Tumblr, YouTube the notion of a social graph is ever more important, at a personal level for the user, at a commercial level for marketers of products and services, and even for law enforcement agencies. To explain these embodiments, let us look at sensor deployment system 600 illustrated in FIG. 12 and FIG. 13. FIG. 12 depicts social graph 602, for example, from one of the popular social networking sites mentioned above. The objective of the application is to ‘reach out’ to persons 602 in social graph marked with circles containing an ‘X’ in FIG. 10. An example use-case for such a requirement could be an election campaign or some other social community outreach campaign. In the present embodiment of the instant invention, persons 604 marked with ‘X’ comprise the ground set X, and their target sites comprise their locations in social graph 602 i.e. circles 604 marked with ‘X’ in FIG. 12.

Sensing stations are all other persons in the social graph shown by blank circles 606 in FIG. 12. As in the case of target sites above, the candidate sites are the correspondent locations of sensing stations in social graph 602 shown by blank circles 606 in FIG. 12. Using the present embodiment of the instant invention to achieve the application objective, the computed solution is presented in FIG. 13. FIG. 13 illustrates that the individuals marked with circles 608 containing A, B, C represent the placement sites where sensing stations need to be deployed. In other words, ‘popular’ persons with respect to target nodes 604 marked with an ‘X’, are nodes 608 marked with ‘A’, ‘B’, ‘C’ in social graph 602 as shown in FIG. 12. Nodes 608, marked with ‘A’, ‘B’, and ‘C’ provide the minimum set-cover or the subset of social graph 602 that is able to reach with the fewest number of placement sites or nodes, all target sites or nodes in social graph 602.

The significance of such a capability is profound from a marketing and outreach perspective. One can easily conceive of marketing and outreach campaigns that are designed to reach certain demographics or subsets of the social graph of a community. An exemplary situation will be an election candidate reaching out to a certain subset of the population. Note that in an alternative but similar embodiment, the ground set X may not comprise people, but rather products. For example, in marketing analysis a marketer is interested in knowing what customers are using what products. In such a situation an alternative graph comprising people and the products they are using may be constructed and used as the workspace for the present embodiment, and the desired analytical objectives achieved.

Indeed the definitions of sensing and sensed regions are applicable to the above embodiments having a social graph as the workspace. While in the example above, sensing region of sensing stations shown by circles 608 in FIG. 13 consist of a single edge of the graph, one can easily extend the sensing region to include multiple edges. So using the example of a social networking community one can design marketing campaigns that reach out to not just the ‘friends’ of a popular person (sensing station) but rather friends of friends, or friends of friends of friends, and so on. Similarly a sensed region or a person of interest (shown by circles 604 marked with ‘X’ in FIG. 12 and FIG. 13) may allow themselves to be reachable by not just their direct friends, but their friends' friends, or their friends' friends' friends and so on.

One can also easily extend the notions of sensing and network coverages taught above to the present embodiments using a social graph. While a sensing coverage in a social graph implies the knowledge or the existence of person within the sensing or sensed regions as per above definitions, a network coverage would allow communication between popular persons and their friends, and their friends and so on.

The aforementioned embodiments of the invention assume target sites that are monitored by sensing stations or target sites where sensed stations are placed, as locations or points in the workspace. Now we will build upon those teachings to disclose an alternative set of embodiments that are based on target regions that need to be monitored or sensed by sensing stations. Such target regions can be as a result of a decomposition of the workspace or its region of interest, into a grid, or cells, or as a result of some other scheme for the creation of target regions of any shape or size whose coverage is required. This process of decomposition of a space into one or more geometric shapes is also sometimes referred to as tessellation or cell-decomposition, as will be familiar to skilled artisans.

An embodiment of the above type is illustrated in the sensor deployment system 700 of FIG. 14 where workspace 702 comprises a set of candidate sites 708 marked by ‘X’, where sensing stations can be placed, and a region of interest 710. The region of interest 710 further consists of a number of regions. Note in the embodiment shown in FIG. 14 these regions consist of polygons however the teachings of the present invention extend to any geometric shapes besides polygons that are required to be monitored. Further, for clarity, the embodiment shown in FIG. 14 is in two-dimensions, however as previously stated, the teachings of the present invention extend directly to higher-dimensional environments such as 3-D.

In FIG. 14, region of interest 710 consists of several target regions that are required to be monitored. Specifically, the regions that need to be monitored are marked with an ‘X’ (underlined) as shown in FIG. 14. Additionally, region of interest 710 in workspace 702 belonging to sensor deployment system 700 also includes several obstructions 706 as shown. According to the instant invention, for these alternative set of embodiments having target regions instead of target sites or locations as in earlier embodiments, a sensing region vₖ(p) of a sensing station at a candidate site p is defined as a collection of all those target regions in the workspace such that the sensing station is able to sense each such target region if the sensing station can sense a sensed station located anywhere in a certain portion of the target region as determined by a measure C of the target region above a predetermined threshold, despite the present obstructions.

Explained further, in these alternative embodiments, a sensing station at a candidate site p can sense a target region, if it can sense a sensed station placed in a portion of the target region as determined by a measure C of the target region above a certain threshold. A collection of all such target regions then comprises sensing region vₖ(p) of the sensing station. Measure C can be any property or function of the target region being sensed. In one exemplary embodiment, measure C represents the area of the target region. Such will be the case if the objective is to ensure that certain minimum area of a target region is monitored, provided there were appropriate sensed station(s) or sensor(s) are present in that minimum area. This aspect of the target region having appropriate sensors is sometimes also referred to as instrumentation of the target region. However, in a simple variation of this embodiment where sensed stations merely represents sites or points in the workspace, a target region is visible or able to be sensed by a sensing station at a candidate site p, if the area sensed or covered by the sensing station with sensing region vₖ(p) is above a certain threshold.

In an alternative embodiment, measure C represents the volume of the target region. This will be useful in situations where a certain minimum volume of the target regions needs to be monitored, provided that minimum volume is appropriately instrumented. However, in a simple variation of this embodiment where sensed stations merely represents sites or points in the workspace, a target region is visible or able to be sensed by a sensing station at a candidate site p, if the volume sensed or covered by the sensing station with sensing region vₖ(p) is above a certain threshold.

Let us look at FIG. 15A-C to further explain the notion of a sensing region vₖ(p) for these alternative embodiments of the present invention that involve monitoring target regions, and not just target sites or points of interest. FIG. 15A shows sensor 504 of FIG. 10 having a sensing region 506. A target region from FIG. 14 is reproduced here for explanation and is referenced by reference numeral 550. Sensing region 506 of sensing station 504 covers a certain portion as determined by a measure C of target region 550 in FIG. 15A. According to the instant invention, if measure C of target region 550 represents the area of target region 550 to be covered, and this covered area as shown by the hatched pattern filling target region 550 in FIG. 15A is above a predetermined threshold then target region 550 will be considered sensed by sensing station 504. For example, if the predetermined threshold is 50%, then according the present invention target region 550 will be considered sensed by sensing station 504 in FIG. 15A because more than half of the area of target region 550 is overlapping with sensing region 506 of sensor 504.

Measure C can be any useful property of function of the target region. For example, measure C can represent the portions of the target region that are along a certain path or curve, that may in turn be given by a mathematical expression or equation. Alternatively, measure C can represent certain contours or topographical features of the target region in a three-dimensional environment. Preferably measure C represents a set of discrete spots in the target region that need to be observed. Such spots could be points, or group of points in the target region. Furthermore, each target region could have measure C defined uniquely for that target region, or two or more target regions in the workspace can have the same measure C.

In the current embodiments, the ground set X is the set of target regions representing the collection of all targets regions that are required to be observed. Accordingly for the current embodiments of the invention, and following earlier teachings, there is a set family [symbol] comprising a set of ranges. Each range in the set family [symbol] of ranges corresponds to a given candidate site and represents the subset of target regions from set X that are able to be sensed per above explanation, by a given sensing station when that sensing station is placed at that candidate site. Recall from earlier teachings that a candidate site comprises the location information of sensing station in the workspace, the type of sensor or sensing station deployed, and any other ancillary information about the sensing station. Thus each range in set family [symbol] corresponds to a given sensing station and represents a collection of target regions from set X that are able to be sensed by that sensing station when that sensing station is at the candidate site corresponding to that range in set family [symbol] .

More formally, according to the invention, there is a set family of ranges [symbol] ={R₁, R₂, . . . , Rₘ} whose union is the set X of all target regions, where Rᵢ is the subset of set X of those target regions that are able to be sensed by that sensing station (or that type of sensing station as per above teachings) when it is at a candidate site pᵢ. As before, the sensor deployment system of the current invention then determines the deployment strategy for deploying sensing stations in the workspace by determining a minimum set-cover for set system Σ={X, [symbol] }. Again, as before, the invention has a number of choices for picking an algorithm for determining the solution for minimum set-cover, including preferably the Greedy solution, or preferably any polynomial-time solution, or preferably a solution having a size at most a factor [symbol] (d log dC*) from its optimal size C* where d is the Vapnik-Chervonenkis dimension (VC-dimension) of set system Σ={X, R}, or still preferably using a solution that bounds the above VC-dimension by [symbol] (log h) where h represents the number of obstructions in the workspace.

In the preferred embodiment, the threshold is set to be 100% of measure C of the target region. In situations where measure C represents the area or volume of a target region, this variation of the previous embodiment covers the more restrictive case when the requirement is for the target region to be fully contained in the sensing region. This scenario is depicted in FIG. 15B where target region 550 is fully covered by sensing region 506 of sensor 504. To complete this discussion, FIG. 15C represents a scenario where less than half the area of target region 550 is covered by sensing region 506 of sensor 504. So if the threshold of minimum coverage is 50% of the area, target region 550 of FIG. 15C will not be considered sensed by sensing region 506 of sensing station 504 of FIG. 15C.

In another preferred variation of the above embodiment, C represents the minimum number of locations or points within the target region that are required to be sensed. Such an embodiment is depicted in FIG. 16 where target region 552 has six discrete points of interest shown by ‘X’ (underlined). If the threshold requirement is that at least four of these points of interest should be covered by sensing region 506 of sensor 504, then target region 552 as shown in FIG. 16 will be considered covered or sensed by sensing station 504. However, if the threshold requirement for C is give points, then target region 552 of FIG. 16 will not be covered by sensor 504. In this embodiment, there needs to be a mechanism to determine if a point ‘X’ is contained in sensing region 506 of sensor 504. There are several techniques available to skilled artisans, such as ray-casting, to make such a determination. Ray-casting determines if a point is contained in a polygon of size n. The algorithm works as follows:
1. Cast a ray in any direction starting from the point of interest.
2. Count the number of polygon edges intersected by the ray.
3. If the count in step (2) is odd then point p is inside the polygon, otherwise it is outside of the polygon.

Such techniques are well understood in the art and will not be delved into further in this specification. For example, in the embodiment discussed earlier where measure C represents the area of a target region, and if the threshold is 100%, there needs to be a mechanism to determine if the target region is fully contained in a sensing region vₖ(p) of a sensing station at a candidate site p. This can be achieved by implementing “A Simple Linear Algorithm for Intersecting Convex Polygons” by Godfried T. Toussaint (1985). Recall that in the embodiment described in relation to FIG. 16, measure C represents a number of spots or points that were required to be observed to be above a certain threshold. A spot here could mean a single point or a collection of points. In other words, measure C could prescribe a number of spots for the target regions of the embodiment with a threshold requirement of observing a minimum number of such spots, and each such spot comprises a single point or a collection of points.

Those familiar with the art will realize that the above embodiments of the instant invention where the workspace has target regions or cells apply to a highly useful set of applications in the field of cellular communication technology. Specifically, a geographical region is decomposed into the cells of a cellular communication coverage and the above embodiments apply directly to such a cellular structure in three-dimensions where a certain volume or area of the cell, or a certain minimum number of points within each cell need to be covered by a cellular tower/antenna (our sensing station), in order to cover the entire cell (our target region).

A two-dimensional cellular or grid decomposition is shown in the sensor deployment system 800 of FIG. 17, in which workspace 802 has obstructions 804 and has the grid decomposition as shown. Furthermore sensor 106 from FIG. 3 with the star-shaped polygon sensing region is also present in workspace 802.

Workspace 802 is decomposed into the symmetrical cells of the grid as marked by ‘Y’. Note however that the teachings of the instant invention apply to any asymmetrical decomposition of the workspace or its region of interest in two, three or higher dimensions as mentioned earlier.

Now let us impose the requirement in the cell-decomposed or grid embodiment shown in FIG. 17 that measure C represents the area of the cells and further the threshold requirement that in order for a cell to be covered by sensing station 106, at least half of the area of that cell needs to be covered by sensing station 106 with the star-shaped polygonal sensing region shown with the hatched pattern. In other words, we are setting the threshold of coverage to be 50% of the area. Based on this requirement, FIG. 17 shows the various cells in workspace 802 that are covered by a single prime “Y′”, and cells that are only partially covered and do not satisfy the above requirement of at least 50% coverage are shown by double prime “Y″”.

In another variation of the above embodiments a sensing region vₖ(p) of a sensing station at a candidate site p is defined as a collection of all those target regions in the workspace such that the sensing station is able to sense each such target region if the sensing station can communicate with a sensed station located anywhere in a certain portion of the target region as determined by a measure C of the target region above a predetermined threshold, despite the present obstructions. Explained further, in these alternative embodiments, a sensing station at a candidate site p can sense a target region, if it can ‘talk to’ or communicate with a sensed station placed in a portion of the target region as determined by a measure C of the target region above a certain threshold. A collection of all such target regions then comprises sensing region vₖ(p) of the sensing station. Again, measure C can be any property or function of the target region being sensed, including specific points of interest, a portion of the area or volume as determined by a curve, certain topographical features, etc.

The reader will observe that as with the earlier embodiments of the invention that had target sites or point, the above definition expands the notion of coverage in the current embodiments that have target regions, beyond sensing coverage to network coverage. Note, earlier teachings of sensing coverage related to FIG. 14-17 apply to the current embodiment except that instead of just monitoring a target region by determining the presence/absence of signal from sensed station(s), the sensing station(s) are communicating with the sensed station(s) in an area, volume or a measure C of the target region that is above a certain predetermined threshold. Such communication between sensing and sensed station(s) can take any form including but not limited to sending and receiving messages that may contain just ‘pings’ or data payload, sending and receiving different types of electromagnetic radiation patterns to mean different things, sending and receiving different types or strengths of electrical/electronic signals to mean different things, sending and receiving different types or strengths of audio signals to encode different meanings and varying any characteristic of a physical signal to encode messages, etc.

In one exemplary embodiment, measure C represents the area of the target region. Such will be the case if the objective is to ensure that certain minimum area of a target region can be monitored by communicating with the appropriate sensed station(s) or sensor(s) if they were present in that minimum area. In an alternative embodiment, measure C represents the volume of the target region. This will be useful in situations where a certain minimum volume of the target regions needs to be monitored by communicating with the appropriate sensed station(s) or sensor(s) if they were present in that minimum volume.

In another exemplary embodiment, measure C is a length of the perimeter of the target region. In an alternative variation of this embodiment, measure C is a number of vertices of the target region. Such embodiments are useful for applications where there is a requirement of providing/guarding a ‘fence’ around the target region as measured by the fraction of the overall length of the perimeter, or a minimum number of vertices of the perimeter of the target region. In these embodiments, the requirement will be to monitor the sensed stations placed on the perimeter of the target region, despite the present obstructions. An example scenario would be to monitor the fence of a target region for intrusion or extrusion by objects of interest.

The earlier teachings and embodiments of the invention having target sites or points in the workspace, apply equally to the case of a workspace having target regions. In other words the only difference between the two sets of embodiments is that in the case of target regions in the workspace, we are interested in determining the coverage of a target region instead of a target site or point in the workspace, and have accordingly set the ground set X to be the set of all target regions, instead of target sites, and have also accordingly expanded the definition of a sensing region vₖ(p) of a sensing station at a candidate site p to include a measure of choice C that needs to be above a certain threshold in order for the whole target region to be considered sensed or visible, as taught above. Further as taught above, we have accommodated for the corresponding effect of this definition of sensing region vₖ(p) on set family [symbol] ranges to be subsets of target regions from set X, as opposed to target sites, or points.

For example, in the embodiments illustrated in FIG. 12-13, in relation to a social graph, a target region could comprise a group of nodes in the graph marked with ‘X’ such that if a certain minimum number or threshold of those nodes (target region) are reachable from node A, B or C (sensing station), then the whole group is considered reachable. Such a scenario is not uncommon in a group of friends on a social networking site, where if an outreach message could reach a certain number (or higher) of the members of the group, then the message can be assumed to have reached the entire group. Similarly, if a certain number (or higher) of the members of the group are using a certain product, then it can be assumed that the whole group is using the product—for marketing purposes.

In a preferred variation of the above embodiment, the target region is a clique in the social graph. Those familiar with the art will know from graph theory that a clique in an undirected graph is a subset of its vertices such that every two vertices in the subset are connected by an edge. Cliques in a social graph can represent the group of people who are just ‘friends’, or group of people who are friends and also communicate with each other more regularly and/or intensely than with their other friends. The present invention then is applied for determining a set-cover of the cliques that are above a measure C that is suitably defined for the application. The measure C can be the number friends in the clique, their frequency or intensity of communication, topics discussed, etc.

Similarly, in the embodiment where a sensing station is a three-dimensional object in a video, the workspace itself can be the video that comprises of various segments (target regions). In this embodiment, where the video can be pre-recorded or streaming, the objective of the application could be to provide coverage for each segment of the video, such that a segment is considered covered by a camera, if the length of the segment videographed by the camera is above a certain percentage of the entire length of the segment (threshold).

In the exemplary embodiment where the sensing and sensed stations are persons or other living/non-living objects, the workspace as a geographical area can comprise a set of candidate sites and target regions in the geographical area. An example use-case for such an embodiment is ensuring that celebrities (sensed stations) at the Academy Awards ceremony or The Oscars at Dolby Theater in Hollywood (workspace) are adequately covered by NBC videographers (sensing stations). The workspace in this can be considered to include the target regions where the celebrities are present (seating area). Another example could be vehicles in a parking lot or a transportation hub that need to be tracked by sensors, with the parking lot (workspace) comprising of discrete parking spots for the vehicles (target regions), etc.

The methods of the present invention further delineate the steps required to execute the sensor deployment strategy of the present invention taught above. The methods provide the steps for determining the placement sites from a set of candidate sites [p₁, p₂, . . . , pₘ] for sensing stations in a workspace, by first providing sensed stations in target regions in the workspace, and representing all such target regions by set X. They further provide zero or more obstructions in the workspace, and then provide one or more sensing regions vₖ(p) around each sensing station when the sensing station is at a candidate site p in the workspace. Sensing region vₖ(p) of a sensing station at a candidate site p is defined as a collection of all those target regions in the workspace such that the sensing station is able to sense each such target region if the sensing station can sense a sensed station located anywhere in a certain portion of the target region as determined by a measure C of the target region above a predetermined threshold, despite the present obstructions.

Explained further, in these alternative embodiments, a sensing station at a candidate site p can sense a target region, if it can sense a sensed station placed in a portion of the target region as determined by a measure C of the target region above a certain threshold. A collection of all such target regions then comprises sensing region vₖ(p) of the sensing station. Measure C can be any property or function of the target region being sensed.

In related embodiments, the invention further extends the definition of sensing region vₖ(p) beyond sensing coverage to include communication and hence provide network coverage. Consequently in such embodiments, a sensing station at a candidate site p can sense a target region, if it can ‘talk to’ or communicate with a sensed station placed in a portion of the target region as determined by a measure C of the target region above a certain threshold. A collection of all such target regions then comprises sensing region vₖ(p) of the sensing station. Again, measure C can be any property or function of the target region being sensed, including specific points of interest, a portion of area as determined by a curve, certain topographical features, etc.

The methods further provide a sensing range and a sensing orientation to constrain sensing region vₖ(p) of each sensing station, and then provide a composite sensing region v(p) of a sensing station to be the collection of the individual k sensing regions vₖ(p) when the sensing station is at candidate site p in the workspace. Furthermore, set family [symbol] ={R₁, R₂, . . . , Rₘ} whose union is the target set X is created, such that a sensing station at a candidate site pᵢ in the workspace is able to sense the target regions in set R_{L} belonging to set family according to the above definition of sensing. Then the step to choose the placement sites from the set of candidate sites {p₁, p₂, . . . , pₘ} for the sensing stations in the workspace is performed by computing a minimum set-cover for set system Σ={X, [symbol] }. As taught earlier, the minimum set-cover can be computed using the popular Greedy algorithm, or a variation thereof, or any other suitable algorithm appropriate for the application at hand.

In view of the above teaching, a person skilled in the art will recognize that the methods of present invention can be embodied in many different ways in addition to those described without departing from the principles of the invention. Therefore, the scope of the invention should be judged in view of the appended claims and their legal equivalents.

What is claimed is:

1. A system of determining a set of placement sites from a set of candidate sites {p₁, p₂, . . . , pₘ} for at least one sensing station in a workspace, comprising:
a) at least one sensed station, each said sensed station in a target region in said workspace, said target regions represented by set X;
b) zero or more obstructions in said workspace;
c) at least one sensing region vₖ(p) around each said at least one sensing station when said sensing station is at a candidate site p in said workspace, as a collection of each said target region such that said sensing station is able to sense said target region if said sensing station can sense said at least one sensed station in said target region when said sensed station is located anywhere in a portion of said target region as given by a measure C of said target region above a predetermined threshold, notwithstanding said obstructions;
d) a sensing range and a sensing orientation of said at least one sensing station constraining its said at least one sensing region vₖ(p);
e) a composite sensing region v(p) of each said at least one sensing station as a collection of all said k sensing regions vₖ(p) when the corresponding sensing station is at said candidate site p in said workspace;
f) a set family [symbol] ={R₁, R₂, . . . , Rₘ} whose union is said set X and said at least one sensing station at a candidate site pᵢ in said workspace is able to sense each said target region in set Rᵢ;
wherein said set of placement sites are chosen from said set of candidate sites {9₁, p₂, . . . , pₘ} based on a minimum set-cover for set system Σ={X, [symbol] }.

2. The system of claim 1 wherein said measure C represents a number of spots within said target region.

3. The system of claim 1 wherein said measure C represents one of area, volume, a fraction of the perimeter length or a number of vertices of said target region.

4. The system of claim 1 wherein said threshold equals 100% of said measure C.

5. The system of claim 1 wherein said target regions represent cells in a grid decomposition of said workspace.

6. The system of claim 1, wherein said composite sensing region v(p) for each said at least one sensing station is a union of said k sensing regions vₖ(p) when said sensing station is at said candidate site p in said workspace.

7. The system of claim 1, wherein said composite sensing region v(p) for each said at least one sensing station is an intersection of said k sensing regions vₖ(p) when said sensing station is at said candidate site p in said workspace.

8. The system of claim 1, wherein said composite sensing region v(p) for each said at least one sensing station is based on a set operation defined on said k sensing regions vₖ(p) when said sensing station is at said candidate site p in said workspace.

9. The system of claim 1, wherein said at least one sensed station merely represents the location of said at least one sensed station in said target region.

10. The system of claim 1, wherein said set X represents the entirety of said workspace.

11. The system of claim 1, wherein said set of placement sites guarantees that each said target region is able to be sensed by two or more said at least one sensing stations, when said sensing stations are at said placement sites.

12. The system of claim 1 wherein each said candidate site further comprises the three-dimensional coordinates of the location of said candidate site in said workspace and said sensing orientation in three-dimensional Euclidean space of said at least one sensing station at said location.

13. The system of claim 1 wherein each said candidate site further comprises the three-dimensional coordinates of the location of said candidate site in said workspace and said sensing orientation in three-dimensional Euclidean space of said at least one sensing station at said location is unconstrained.

14. The system of claim 1 wherein each said candidate site further comprises the two-dimensional coordinates of the location of said candidate site in said workspace and said sensing orientation in two-dimensional Euclidean space of said at least one sensing station at said location.

15. The system of claim 1 wherein each said candidate site further comprises the two-dimensional coordinates of the location of said candidate site in said workspace and said sensing orientation in two-dimensional Euclidean space of said at least one sensing station at said location is unconstrained.

16. The system of claim 1, wherein there is a predetermined number of said at least one sensing stations.

17. The system of claim 1, wherein the locations of said placement sites in said workspace can only be chosen from a predetermined set of locations in said workspace.

18. The system of claim 1, wherein the locations of said placement sites in said workspace can only exist in a predetermined region in said workspace.

19. The system of claim 1, wherein said candidate sites {p₁, p₂, . . . , pₘ} overlap with said target regions in said set X in said workspace.

20. The system of claim 1, wherein said candidate sites {p₁, p₂, . . . , pₘ} do not overlap with said target regions in said set X in said workspace.

21. The system of claim 1, wherein said minimum set-cover is derived based on a Greedy algorithm solution.

22. The system of claim 1, wherein said minimum set-cover is derived based on a polynomial-time solution.

23. The system of claim 18, wherein said solution is of size at most a factor [symbol] (d log dC*) from its optimal size C* where d is the Vapnik-Chervonenkis dimension (VC-dimension) of said set system Σ={X, [symbol] }.

24. The system of claim 19, wherein said Vapnik-Chervonenkis dimension is bounded by [symbol] (log h) where h represents the number of said obstructions.

25. The system of claim 1, wherein said at least one sensing station comprises a camera and said set X comprises a surveillance space.

26. The system of claim 1, wherein said at least one sensing station comprises wireless sensor(s) operating substantially at a frequency of 60 GHz.

27. The system of claim 1, wherein said at least one sensed station comprises wireless sensor(s) operating substantially at a frequency of 60 GHz.

28. The system of claim 1, wherein said workspace comprises a video.

29. The system of claim 1, wherein said at least one sensing station comprises one of a person or product, and said workspace comprises a social graph.

30. The system of claim 29, wherein said target regions are cliques in said social graph.

31. The system of claim 1, wherein said workspace is a geographical place, said at least one sensing station and said at least one sensed station comprise living beings, said candidate sites comprise geo-location coordinates and said target regions comprise locations in said geographical place.

32. The system of claim 1, wherein said workspace is a geographical place, said at least one sensing station and said at least one sensed station comprise objects, said candidate sites comprise geo-location coordinates and said target regions comprise locations in said geographical place.

33. A system of determining a set of placement sites from a set of candidate sites {p₁, p₂, . . . , pₘ} for at least one sensing station in a workspace, comprising:
a) at least one sensed station, each said sensed station in a target region in said workspace, said target regions represented by set X;
b) zero or more obstructions in said workspace;
c) at least one sensing region vₖ(p) around each said at least one sensing station when said sensing station is at a candidate site p in said workspace, as a collection of each said target region such that said sensing station is able to sense said target region if said sensing station can communicate with said at least one sensed station in said target region when said sensed station is located anywhere in a portion of said target region as given by a measure C of said target region above a predetermined threshold, notwithstanding said obstructions;
d) a sensing range and a sensing orientation of said at least one sensing station constraining its said at least one sensing region vₖ(p);
e) a composite sensing region v(p) of each said at least one sensing station as a collection of all said k sensing regions vₖ(p) when the corresponding sensing station is at said candidate site p in said workspace;
f) a set family [symbol] ={R₁, R₂, . . . , Rₘ} whose union is said set X and said at least one sensing station at a candidate site pᵢ in said workspace is able to sense said target regions in set Rᵢ;
wherein said set of placement sites is chosen from said set of candidate sites {p₁, p₂, . . . , pₘ} based on a minimum set-cover for set system Σ={X, [symbol] }.

34. A method for determining a set of placement sites from a set of candidate sites {p₁, p₂, . . . , pₘ} for at least one sensing station in a workspace, comprising the steps of:
a) providing at least one sensed station in a target region in said workspace, and representing said target regions by set X;
b) providing zero or more obstructions in said workspace;
c) providing at least one sensing region vₖ(p) around each said at least one sensing station when said sensing station is at a candidate site p in said workspace, to be a collection of each said target region such that said sensing station is able to sense said target region if said sensing station can sense said at least one sensed station in said target region when said sensed station is located anywhere in a portion of said target region as given by a measure C of said target region above a predetermined threshold, notwithstanding said obstructions;
d) providing a sensing range and a sensing orientation for each said at least one sensing station to constrain its said at least one sensing region vₖ(p);
e) providing a composite sensing region v(p) for each said at least one sensing station to be a collection of all said k sensing regions vₖ(p) when said sensing station is at said candidate site p in said workspace;
f) providing a set family [symbol] ={R₁, R₂, . . . , Rₘ} whose union is said set X and said at least one sensing station at a candidate site pᵢ in said workspace is able to sense each said target region in set Rᵢ; and choosing said placement sites from said candidate sites {p₁, p₂, . . . , pₘ} based on a minimum set-cover for set system Σ={X, [symbol] }.

35. A method for determining a set of placement sites from a set of candidate sites {p₁, p₂, . . . , pₘ} for at least one sensing station in a workspace, comprising the steps of:
a) providing at least one sensed station in a target region in said workspace, and representing said target regions by set X;
b) providing zero or more obstructions in said workspace;
c) providing at least one sensing region vₖ(p) around each said at least one sensing station when said sensing station is at a candidate site p in said workspace, to be a collection of each said target region such that said sensing station is able to sense said target region if said sensing station can communicate with said at least one sensed station in said target region when said sensed station is located anywhere in a portion of said target region as given by a measure C of said target region above a predetermined threshold, notwithstanding said obstructions;
d) providing a sensing range and a sensing orientation for each said at least one sensing station to constrain its said at least one sensing region vₖ(p);
e) providing a composite sensing region v(p) for each said at least one sensing station to be a collection of all said k sensing regions vₖ(p) when the corresponding sensing station is at said candidate site p in said workspace;
f) providing a set family [symbol] ={R₁, R₂, . . . , Rₘ} whose union is said set X and said at least one sensing station at a candidate site pᵢ in said workspace is able to sense each said target region in set Rᵢ; and
choosing said placement sites from said candidate sites {p₁, p₂, . . . , pₘ} based on a minimum set-cover for set system Σ={X, [symbol] }.
